(19) United States
(12) Patent Application Publication
(10) Pub. No.: US 2026/0297249 A1
(43) Pub. Date: Oct. 1, 2026

(54) ACCELERATED PEROXIDE-CURED RESIN COMPOSITIONS HAVING EXTENDED OPEN TIMES

(71) Applicant: Arkema Inc., King of Prussia, PA (US)

(72) Inventors: Lisa B. RACHWAL, King of Prussia, PA (US); Evan CROCKER, King of Prussia, PA (US); Marina DESPOTOPOULOU, King of Prussia, PA (US); Leonard H. PALYS, King of Prussia, PA (US)

(21) Appl. No.: 19/483,296

(22) PCT Filed: May 9, 2024
(86) PCT No.: PCT/US2024/028574

§ 371 Date: Nov. 11, 2025

Related U.S. Application Data
(60) Provisional application No. 63/465,921, filed on May 12, 2023.

(51) Int. Cl. C08G 63/91; C08J 5/24; C09D 167/06

(52) U.S. Cl. CPC C08G 63/91; C08J 5/24; C09D 167/06; C08J 2367/06

(57) ABSTRACT

Curable resin compositions having extended open limes al ambient temperatures find short cure times at elevated temperatures are prepared using a curable resin winch is curable with one or more liquid organic peroxides or a blend thereof and an accelerator/activator promoter comprising a metal salt and a thiol-functionalized organic compound.

### TECHNICAL FIELD

The present disclosure pertains to resin compositions which are capable of being cured using liquid organic peroxides, organic peroxide formulations, and blends thereof and which have an extended pot life (open time) at ambient (room) temperatures and yet can be quickly cured at higher temperatures, thereby making them particularly suitable for use in composite applications such as pultrusion, cure-in-place pipes, and resin transfer molding.

### BACKGROUND

Composites based on curable thermoset resins such as unsaturated polyester resins and vinyl ester resins combined with optional reinforcing fillers such as glass or carbon fibers typically exhibit advantageous mechanical properties such as high strength and rigidity. Curing of the resins in such systems often is achieved by initiation of free radical reactions using organic peroxides, leading to crosslinking of the curable resin. In at least some end-use applications for such composite systems, it is desirable for the resin to cure rapidly upon heating to an elevated temperature, in order to lower production costs and increase the efficiency of a composite manufacturing operation. Heating a curable resin containing peroxide may cause the peroxide to decompose and generate free radical species, which then initiate curing of the resin, resulting in the hardening of the liquid resin and providing the improved physical properties desirable in a composite system. A composite is considered cured when the physical form and shape of the composite part is permanently fixed or permanently hardened at the expected utilization temperature of the composite part to provide a rigid, thermoset composite part. At the same time, however, the curable resin/peroxide/reinforcing filler mixture or blend should desirably have a relatively slow rate of cure at ambient (room) temperature, to provide sufficient time for such a mixture or blend to be shaped into a target form for the composite part. In the present disclosure, the curable thermoset resins such as unsaturated polyester resins and optional reinforcing fillers are cured by organic peroxides, organic peroxide formulations, and blends thereof as described herein.

Generally speaking, elevated temperature cures in which organic peroxides are used depend upon the thermal degradation of such organic peroxides to initiate polymerization of curable resins such as unsaturated polyester resins. In order to achieve cure times short enough to ensure reasonable cycle times, peroxides with relatively short half-lives at room temperature are used as primary initiators. Such peroxides generally are selected from certain peroxyesters or peroxydicarbonates which must be stored at sub-ambient (freezing) temperatures due to their instability, such as tert-butyl peroxyneodecanoate, or solid peroxydicarbonates such as di(2-ethylhexyl) peroxydicarbonate or di-(4-tert-butylcyclohexyl) peroxydicarbonate.

While effective, such types of peroxides are not optimal as they either require freezer storage (in the case of the liquid peroxides) which may increase storage costs and safety risks or (in the case of the solid peroxides) require additional effort and costs to disperse into a curable resin and are regulated with respect to storage due to their fire code classification.

Traditional composite applications generally use one of two classes of initiation packages, either a mixture of a solid (or paste) peroxydicarbonate as the primary initiator, or a mixture based on freezer storage. An example of a solid peroxydicarbonate is di(4-tert-butylcyclohexyl) peroxydicarbonate (known under the tradenames of Perkadox® 16, or Norox® 600-CL2). This solid peroxydicarbonate peroxide has a recommended storage temperature of 20° C., but only in its solid form. A liquid solution form of this peroxide would require freezer storage temperatures. Examples of liquid freezer storage peroxides are LUPEROX® 223 and LUPEROX® 10. Both types of systems have disadvantages. The solid organic peroxide system requires significant mixing into the resin to ensure proper dispersion and dissolution. Therefore, it is often diluted into styrene or another solvent before introduction to the resin, thereby increasing cost, inefficiencies, processing steps, and possible harmful exposure to the environment.

It is also known to those of skill in the art that organic peroxide classes such as, peroxyesters, hemi-peroxyketals, peroxyketals, monoperoxycarbonates, ketone peroxides, diacyls and hydroperoxides should not come into direct contact with transition metal salts because transition metal salts generally are considered destabilizing agents in the presence of these organic peroxides. These transition metal salts or metal soaps are often referred to as accelerators, or activators or promotors in the art. Furthermore, it is also recommended that these peroxides should not come into contact with the transition metal itself, for example iron or copper. For example, many Safety Data Sheets for organic peroxides caution that transition metal salts, metal soaps and/or metal activators are storage incompatible with organic peroxides.

U.S. Pat. No. 4,380,605 discloses crosslinking of unsaturated polyester resins at room temperature in the presence of a peroxyester initiator is accelerated by a mercapto compound and a metal salt wherein the metal is selected from the group consisting of copper, and iron, or a mixture of the metal salts.

U.S. Pat. No. 5,310,826 discloses accelerator compositions for the free radical polymerization of unsaturated polyesters and for the curing of unsaturated polyesters and polyurethanes.

U.S. Pat. No. 5,235,010 discloses accelerator compositions for curing various unsaturated resins which include a complex of a salt of certain metals with an oxygen-containing compound, wherein a thiol compound may also be present. A peroxide initiator may be employed in combination with such complexes.

U.S. Pat. Appln. Pub. No. 2010/0120977 A1 discloses an accelerator solution comprising a complexing agent selected from the group consisting of complexing agents having a nitrogen atom and a hydroxyl group and bipyridine, a salt of a metal selected from the group consisting of transition metal, magnesium, and lithium, and optionally a solvent.

U.S. Pat. Appln. Pub. No. 2011/0250373 discloses the use of nitroxides to control free radical cured resin systems in the production of thermosetting materials, wherein a radical initiator free radical polymerization initiator selected from diacyl peroxides, peresters, peroxydicarbonates and mixtures thereof may be utilized.

International Publication No. WO 2008/003496 describes a two-component composition comprising a first component and a second component, wherein the first component is a resin composition comprising an unsaturated polyester resin or vinyl ester resin, a manganese compound and a thiol-containing compound and the second component comprises hydrogen peroxide or an alkyl hydroperoxide.

U.S. Pat. No. 11,873,381 discloses a curable resin composition including a curable resin, a room-temperature-stable organic peroxide, other than a perketal, which is liquid at 25° C., a room-temperature-stable perketal which is liquid at 25° C., a metal salt, a thiol-functionalized organic compound, and a free radical trap. The curable resin composition remains substantially liquid at 25° C.

### SUMMARY

A curable resin composition prepared using a curable unsaturated polyester resin that is curable with at least one liquid organic peroxide formulation and which is blended with a first component including at least one non-room-temperature-stable liquid organic peroxide and at least one room-temperature-stable liquid organic peroxide, and a second component (also known as the accelerator/activator/promoter) including at least one metal salt, at least one thiol-functionalized organic compound combined with optional solvents is provided.

The non-room-temperature liquid organic peroxide formulation is defined as one that has a 1 hour half-life that is less than 100° C.; whereas the room-temperature liquid organic peroxide formulation has a 1 hour half-life that is equal to 100° C. or more.

Preferred curable resins can include (meth)acrylate resins, unsaturated polyester resins and vinyl ester resins. The curable resin may contain reinforcing fillers. The curable resin compositions can be kept refrigerated to extend shelf life, prior to a cure operation. The curable resin composition is useful in pultrusion, cure-in-place pipe (CIPP) and resin transfer molding (RTM) applications, among others. Furthermore, the first and second components may be blended together prior to combining with the curable resin. Thus, the transition metal salt (such as ZnCl₂) dissolved in an appropriate solvent and the thiol organic compound can be safely blended with the various organic peroxides with no visible reaction for a several hours at ambient temperatures. This result is unexpected, since transition metal halides are known promotors for the decomposition of organic peroxides.

Additionally, the inventors surprisingly discovered that it is possible to mix the peroxide blend components with the accelerator/activator/promoter component (the metal salt and the thiol-functionalized organic compound), without the use of any free-radical traps including those of the nitroxide type (e.g., TEMPO (2,2,6,6-tetramethylpiperidine 1-oxyl), 4-OH TEMPO, or SG-1 nitroxide) and quinone type (e.g., MTBHQ or mono-tert-butyl hydroquinone. HQMME or hydroquinone monomethyl ether).

Surprisingly, preferred organic peroxide formulations containing an accelerator component described in this disclosure are relatively stable. Stable means that the formulations (compositions or blends) do not undergo immediate decomposition at temperatures ranging up to 18, or 19, or 20, or 21, or 22, or 23, or 24, or 25, or 26, or 27, or 28, or 28, or even up to 30° C., which is measurable by a rise in temperature of the composition, for at least 1 hour, or at least 2-3 hours, or at least 5-8 hours, or at least 8-10 hours, or at least 10-15 hours, or up to even 24 hours. Such an organic peroxide-activator composition provides an added benefit of enabling a more thorough blend of the peroxide and activator into the unsaturated polyester resin. Once the peroxide blend including the metal salt and thiol-functional organic compound is added to the curable resin and once heat is applied, the resin will then begin to exotherm and cure. In other words, the combination of the metal salt and the thiol-functionalized organic compound as an accelerator/activator/promoter system when added directly to the organic peroxide formulation provides an unexpectedly temperature-stable and complete cure system that nonetheless also provides a fast and effective cure of unsaturated polyester resins at elevated temperatures. The ability to safely store, and then add a blend of a transition metal salt and a thiol-functionalized compound directly to an organic peroxide at ambient temperature, without any immediate organic peroxide decomposition is highly unexpected.

A curable resin composition is provided. The curable resin composition includes:
a) at least one curable resin which is capable of being cured by liquid organic peroxide;
b) at least one room-temperature-stable organic peroxide which is in liquid form at 25° C. and has a one-hour half-life temperature of 100° C. or more;
c) optionally at least one non-room-temperature-stable organic peroxide which is in liquid form at 10° C. or less, and has a one-hour half-life temperature of less than 100° C.;
d) at least one salt of at least one metal including at least one of Li, Al, Mg, Co, Fe, Cu, Zn, Ni, Mn, Cr, Sn. Au, Pd or Pt;
e) at least one thiol-functionalized organic compound; and
f) optionally at least one solvent including at least one of alcohols, glycols, or glycol ethers.

A method of preparing a cured composition is also provided. The method includes the following steps:
combining:
a) at least one curable resin which is capable of being cured by an organic peroxide;
b) at least one room-temperature-stable organic peroxide which is in liquid form at 25° C., and has a one-hour half-life temperature of 100° C. or more
c) optionally at least one non-room-temperature-stable organic peroxide which is in liquid form at 10° C. or less and has a one-hour half-life temperature of less than 100° C.; d) at least one salt of at least one metal including at least one of Li, Al, Mg, Co, Fe, Cu, Zn, Ni, Mn, Cr, Sn, Au, Pd or Pt;
e) at least one thiol-functionalized organic compound; and
f) optionally at least one solvent including at least one of alcohols, glycols, or glycol ethers;
to provide a curable resin composition; and
heating the curable resin composition to a temperature effective to initiate curing of the curable resin composition.

A curing system is also provided. The curing system includes i) a first component and ii) a second component. The first component includes:
at least one room-temperature-stable organic peroxide which is in liquid form at 25° C., and has a one-hour half-life temperature of 100° C. or more; and
at least one non-room-temperature-stable organic peroxide which is in liquid form at 10° C. or less and has a one-hour half-life temperature of less than 100° C.

The second component of the curing system includes:
at least one salt of at least one metal including at least one of Li, Al, Mg, Co, Fe, Cu, Zn, Ni, Mn, Cr, Sn, Au, Pd, or Pt;
at least one thiol-functionalized organic compound; and
optionally at least one solvent including at least one of alcohols, glycols, or glycol ethers.

According to one embodiment, the first component is substantially devoid or devoid of styrene.

A curing system is provided wherein the above i) first component and the ii) second component are combined to form a single, room-temperature-stable liquid curing system.

A curable resin composition is also provided. The curable resin composition includes the following:
a) at least one curable resin comprising at least one of alkyd resins, unsaturated polyester resins, vinyl ester resins, or (meth)acrylate resins, or mixtures or blends thereof, wherein the curable resin is capable of being cured by a liquid organic peroxide;
b) at least one organic peroxide in liquid form selected from the following groups:
   i) room-temperature-stable organic peroxides which are in liquid form at 25° C. and have a one-hour half-life temperature of 100° C. or more; or
   ii)non-room-temperature-stable organic peroxides which are in liquid form at 10° C. or less, and have a one-hour half-life temperature of less than 100° C.; or
   iii) a blend or mixture of organic peroxides (i) and organic peroxides (ii);
c) at least one salt of at least one metal comprising at least one of Li, Al, Mg, Co, Fe, Cu, Zn, Ni, Mn, Cr, Sn, Au, Pd, or Pt;
d) at least one thiol-functionalized organic compound; and
e) optionally at least one solvent comprising at least one of alcohols, glycols, or glycol ethers.

A liquid organic peroxide composition is also provided. The liquid organic peroxide composition includes a blend of the following components:
a first organic peroxide;
a second organic peroxide;
at least one transition metal salt dissolved in a solvent comprising at least one of an alcohol, a glycol, or a glycol ether; and
at least one thiol-functionalized organic compound is provided. The blend is stable for at least 1 hour, preferably at least 2-8 hours, more preferably, at least 8-15 hours, most preferably stable for at least 24 hours, at 18° C. or higher, preferably 20° C. or higher, more preferably 23° C. or higher.

### BRIEF DESCRIPTION OF THE DRAWINGS

FIG. 1 shows results of peroxide cure of an unsaturated polyester resin (UPR) when using our novel accelerator solution according to an exemplary embodiment of the disclosure;

FIG. 2 shows results of a peroxide cure of an UPR when using our novel accelerator solution according to another exemplary embodiment of the disclosure;

FIG. 3 shows unexpected peroxide stability when blended with our novel accelerator solution, followed by effective peroxide exotherm according to an exemplary embodiment of the disclosure;

FIG. 4 shows a comparative example of reduced peroxide stability when the neat peroxide (no resin) is blended with ZnCl₂, a transition metal that is known to destabilize (promote) organic peroxides;

FIG. 5 shows an example of unexpected peroxide stability when neat peroxide (no resin) is blended with the novel accelerator solution of exemplary embodiment of the disclosure;

FIG. 6 shows results of a peroxide cure of an UPR when using our novel accelerator solution according to an exemplary embodiment of the disclosure; and

FIG. 7 shows results of a peroxide cure of an UPR when using our novel accelerator solution according to another exemplary embodiment of the disclosure.

### DETAILED DESCRIPTION OF THE INVENTION

One hour half-life information for a various organic peroxides can be found in LUPEROX® Organic Peroxides Arkema Inc., General Catalog ● Americas and the High Polymers catalog by Arkema (Colombes Cedex), and is incorporated herein in its entirety for all purposes.

The half-life time is the time at which 50% of the peroxide has decomposed at a specified temperature, and the half-life temperature is the temperature at which 50% of the peroxide has decomposed at a specified time, as described in “SAFETY AND HANDLING OF ORGANIC PEROXIDES: A Guide Prepared by the Organic Peroxide Producers Safety Division of Plastics Industry Association”, Plastics Industry Association, Inc., OPPSD Bulletin AS-109 (August 2018), incorporated herein in its entirety for all purposes.

As used herein, the terms, “liquid” and “in liquid form” mean that the material is liquid (flowable or pourable) at the temperature recited and is in the form of a solution or is itself (neat) liquid (flowable or pourable).

As used herein, the term, “stable.” with respect to organic peroxide formulations, compositions or blends means that the formulations (compositions or blends) do not undergo immediate decomposition at temperatures ranging up to 18, or 19, or 20, or 21, or 22, or 23, or 24, or 25, or 26, or 27, or 28, or 28, even up to 30° C. which is measurable by a rise in temperature of the formulation, composition or blend, for at least 1 hour, or at least 2-3 hours, or at least 5-8 hours, or at least 8-10 hours, or at least 10-15 hours, or up to even 24 hours. Such an organic peroxide-activator composition provides an added benefit of enabling a more thorough blend of the peroxide and activator into the peroxide-curable resin. Once the peroxide blend including the metal salt and thiol-functional organic compound is added to the curable resin and once heat is applied, the combination of the resin and peroxide formulation will then begin to exotherm and cure. In other words, the combination of the metal salt and the thiol-functionalized organic compound as an accelerator/activator/promoter system when added directly to the organic peroxide formulation provides an unexpectedly temperature stable and complete cure system that nonetheless also provides a fast and effective cure of curable resins at elevated temperatures. The ability to safely store, and then add a blend of a transition metal salt and a thiol-functionalized compound directly to an organic peroxide at ambient temperature, without any immediate organic peroxide decomposition is highly unexpected.

### Curable Resins

The curable resins as used herein are those that are initially liquid, but polymerize or otherwise react to form a solid (thermoset) article when combined with the organic peroxide formulations and heated.

Suitable curable resins which may be utilized in embodiments of the present disclosure include, but are not limited to, alkyd resins, unsaturated polyester (UP) resins, vinyl ester resins, (meth)acrylate resins (also referred to as acrylic resins), and mixtures thereof. Preferred resins include (meth)acrylate resins, unsaturated polyester resins and vinyl ester resins. In the context of the present application, the terms “unsaturated polyester resin” and “UP resin” refer to combinations of unsaturated polyester resin(s) and ethylenically unsaturated monomeric compound(s) such as styrene, which are typically used to lower the viscosity of the (uncured) unsaturated polyester resin and to facilitate crosslinking and development of physical properties useful to cured composite articles. The term “(meth)acrylate resin” refers to combinations of acrylate and/or methacrylate resins and ethylenically unsaturated monomeric compounds. Such UP resins and acrylate resins are well known in the art and commercially available.

Unsaturated polyester resins useful in embodiment of the disclosure include reactive resins dissolved in a polymerizable monomer or mixture of monomers. These reactive resins are formed by condensing a saturated dicarboxylic acid or anhydride and an unsaturated dicarboxylic acid or anhydride with a dihydric alcohol. Examples of these polyester resins include the products of the reaction of a saturated dicarboxylic acid or anhydride (e.g., phthalic anhydride, isophthalic acid, tetrahydrophthalic anhydride, hexahydrophthalic anhydride, endomethylene tetrahydrophthalic anhydride, tetrachlorophthalic anhydride, hexachloroendomethylene tetrahydrophthalic acid, succinic acid, glutaric acid, adipic acid, pimelic acid, suberic acid, azelaic acid or sebacic acid) and an unsaturated dicarboxylic acid or anhydride (e.g., maleic anhydride, fumaric acid, chloromaleic acid, itaconic acid, citraconic acid or mesaconic acid) with a dihydric alcohol (e.g., ethylene glycol, propylene glycol, butylene glycol, diethylene glycol, triethylene glycol or neopentyl glycol). Small amounts of a polyhydric alcohol (e.g., glycerol, pentaerythritol, trimethyolpropane or sorbital) may be used in combination with the glycol.

According to some embodiments, the curable resin may include at least one of alkyd resins, unsaturated polyester resins, vinyl ester resins, or (meth)acrylate resins, or mixtures or blends thereof. According to some embodiments, the curable resin may include at least one of unsaturated polyester resins, or vinyl ester resins, or combinations thereof. According to some embodiments, the curable resin may include unsaturated polyester resins. According to come embodiments, the curable resin may include vinyl ester resins.

In the case of unsaturated polyester resins, the final three-dimensional (crosslinked) structure may be produced by reacting the unsaturated polyester through the unsaturated acid component of the unsaturated polyester with an unsaturated monomer which is capable of reacting with the unsaturated polyester to form cross-linkages. Suitable unsaturated monomers include styrene, methylstyrene, dimethylstyrene, vinyltoluene, divinylbenzene, dichlorostyrene, methyl acrylate, methyl methacrylate, ethyl acrylate, diallyl phthalate, vinyl acetate, triallyl cyanurate, acrylonitrile, acrylamide and mixtures thereof. The relative amounts of the unsaturated polyester and the unsaturated monomer in the unsaturated polyester resin composition may be varied over a wide range. The unsaturated polyester resin compositions generally contain 20% to 80% by weight of the monomer, the monomer content preferably being in the range from 30% to 70% by weight.

Alkyd resins include resins which are the polymerization products of polyhydric alcohols and polybasic acids modified with monobasic fatty acids, typically including at least some amount of unsaturated fatty acids. The polybasic acid may be a dicarboxylic acid, most usually being represented by phthalic anhydride, isophthalic acid, maleic anhydride, itaconic acid and others. Mixtures of two or more of the acids (or their anhydrides) may also be used. A second acid component is monocarboxylic and is represented by the drying oil acids, such as linoleic acid, linolenic acid, eleostearic acid, and others containing two or more double bonds in carbon to carbon conjugation or in non-conjugate relationship with each other.

Vinyl ester resins include resins prepared by esterification of epoxy resins with unsaturated carboxylic acids such as acrylic acid and methacrylic acid, with the resulting product then dissolved in a reactive solvent such as styrene (typically to a concentration of 35 to 45 percent by weight).

(Meth)acrylate resins include acrylate and/or methacrylate-functionalized substances such as acrylates; methacrylates; diacrylates; and dimethacrylates; higher functionality acrylates and methacrylates, including both monomers and oligomers; as well as combinations thereof.

Non-limiting examples of suitable ethylenically unsaturated monomeric compounds include styrene and styrene derivatives like α-methyl styrene; vinyl toluene; indene; divinyl benzene; vinyl pyrrolidone; vinyl siloxane; vinyl caprolactam; stilbene; but also diallyl phthalate; dibenzylidene acetone; allyl benzene; methyl methacrylate; methyl acrylate; acrylic acid; methacrylic acid, diacrylates, dimethacrylates; acrylamides; vinyl acetate; triallyl cyanurate; triallyl isocyanurate, allyl compounds (such as (di)ethylene glycol diallyl carbonate); chlorostyrene; tert-butyl styrene; tert-butylacrylate; butanediol dimethacrylate; and mixtures thereof. Suitable examples of (meth)acrylate-reactive diluents are PEG200 di(meth)acrylate; 1,4-butanediol di(meth)acrylate; 1,3-butanediol di(meth)acrylate; 2,3-butanediol di(meth)acrylate; 1,6-hexanediol di(meth)acrylate and its isomers; diethyleneglycol di(meth)acrylate; triethyleneglycol di(meth)acrylate; glycerol di(meth)acrylate; trimethylolpropane di(meth)acrylate; neopentyl glycol di(meth)acrylate; dipropyleneglycol di(meth)acrylate; tripropyleneglycol di(meth)acrylate; PPG250 di(meth)acrylate; tricyclodecane dimethylol di(meth)acrylate; 1,10-decanediol di(meth)acrylate; tetraethylene glycol di(meth)acrylate; trimethylolpropane tri(meth)acrylate; glycidyl(meth)acrylate; (bis)maleimides; (bis)citraconimides; (bis)itaconimides; and mixtures thereof.

The amount of ethylenically unsaturated monomer in a curable resin employed in accordance with embodiments of the present disclosure is preferably at least 0.1 wt %, based on the weight of the curable resin component, more preferably at least 1 wt %, and most preferably at least 5 wt %. The amount of ethylenically unsaturated monomer is preferably not more than 50 w, %, more preferably not more than 40 wt %, and most preferably not more than 35 wt %.

Examples of commercially available unsaturated polyester resins suitable for the applications addressed in this disclosure include Pultru® resins from AOC; VIPEL resins from AOC; COR31 and COR30 resins from Interplastic, Aropol® resins from Ashland; and DION and STYPOL resins from Polynt/Reichold.

Examples of commercially available vinyl ester resins suitable for the applications addressed in this disclosure include Pultru® resins from AOC; VIPEL® resins from AOC; CORVE resins from Interplastic; and Derakane® resins from Ashland.

Examples of commercially available (meth)acrylate resins suitable for the applications addressed in this disclosure include MODAR® from Ashland and Elium® from Arkema.

### Organic Peroxides

In one embodiment of the present invention, the curable resins comprise at least one room-temperature-stable organic peroxide which is in liquid form at 25° C. These room-temperature-stable liquid peroxides have a one-hour half-life temperature of 100° C. or more and are capable of curing a curable resin composition, as described herein.

In one embodiment of the present invention, the curable resins comprise at least one non-room-temperature-stable organic peroxide which is in liquid form at 10° C., and has a one-hour half-life temperature of less than 100° C.

In another embodiment the curable resin compositions are characterized by the inclusion of at least two different types of organic peroxides which together are capable of curing a curable resin composition, as described herein. Both types of organic peroxides are advantageously in liquid form, or the blend may be in a liquid form. One type of organic peroxide is storage stable at room temperature, or even at higher temperatures. These are referred to herein as “room-temperature-stable” organic peroxides. They may be safely stored at temperatures of 20° C. or higher, or 25° C. or higher, or up to 30° C. for six months with no more than 2 wt % loss in peroxide concentration. Room-temperature-stable organic peroxides generally have a 1 hour half-life temperature of at least 100° C. These types of room-temperature-stable organic peroxides may have a 10 hour half-life temperature of at least 80° C. or higher. In the context of the present disclosure. “room-temperature-stable” means an organic peroxide which has a maximum recommended storage temperature of 30° C. or higher to maintain no more than 2% loss in peroxide concentration for six months to one year. According to certain aspects of the disclosure, however, the room-temperature-stable organic peroxide present in the curable resin composition may have a ten hour half-life temperature of 80° C. or more. According to still further aspects, the room-temperature-stable organic peroxides exhibit not more than 2% loss in peroxide concentration after being stored for 3, or 6, or 9 or up to 12 months at up to 30° C. or as high as up to 38° C. (100° F.) storage temperature limit. Proper storage temperature limits to maintain organic peroxide assay can be found in material safety data sheets (SDS) or in commercial product catalogs.

The room-temperature-stable organic peroxides useful in embodiments of this disclosure may include: peroxyesters, hemi-peroxyketals, peroxyketals, monoperoxycarbonates, diacyls, ketone peroxides, and hydroperoxides. Preferred room-temperature-stable organic peroxides are peroxyesters, hemi-peroxyketals, peroxyketals, and monoperoxycarbonates. Most preferred are peroxyesters, hemi-peroxyketals, peroxyketals and monoperoxycarbonates type of organic peroxides. Even more preferred are the peroxyesters peroxides, peroxyketals and monoperoxycarbonate peroxides. Still more preferred room-temperature-stable organic peroxides are the peroxyester and monoperoxycarbonate type of peroxides. Preferred and more preferred room-temperature-stable organic peroxides may have tert-butylperoxy, tert-amyl peroxy, tert-hexylperoxy or tert-octylperoxy functionality.

Non-limiting examples of suitable room-temperature-stable organic peroxides are: 1-tert-amyl peroxy-1-methoxy cyclohexane (LUPEROX® V10); 1,1-di(t-butylperoxy)-3,3,5-trimethyl cyclohexane (LUPEROX® 231); 1,1-di(t-amyl peroxy)-cyclohexane (LUPEROX® 531M80); 1,1-di(1-butylperoxy)-cyclohexane (LUPEROX® 331M80); 2,2-di(t-butylperoxy)butane (LUPEROX® 520M50); n-butyl 4,4-di(t-butylperoxy)valerate (LUPEROX® 230); ethyl 3,3-di(t-butylperoxy)butyrate (LUPEROX® PST); OO-tert-butyl-O-(2-ethylhexyl)-monoperoxycarbonate (LUPEROX® TBEC); OO-tert-amyl-O-(2-ethylhexyl)-monoperoxycarbonate (LUPEROX® TAEC); OO-tert-butylperoxy-O-isopropyl-monoperoxycarbonate (LUPEROX® TBICM75); polyether tetrakis(tert-butylperoxycarbonate) (LUPEROX® JWEB-501; di-tert-butyl diperoxyphthalate (LUPEROX® KDB); 2,5-dimethyl-2,5-di(benzoylperoxy)hexane (LUPEROX® 118); tert-butyl peroxybenzoate (LUPEROX® P); tert-amyl peroxybenzoate (LUPEROX® TAP); tert-butyl peroxyacetate (LUPEROX® 7); tert-amyl peroxy acetate (LUPEROX® 555); tert-butyl peroxyacetate (LUPEROX® 7M75); tert-butylperoxy isobutyrate (LUPEROX® 80), 2-butanone peroxide (LUPEROX® DDM-9) or combinations thereof.

Preferred room-temperature-stable peroxides are: hemiperoxyketals; peroxyesters, monoperoxycarbonates; peroxyketals; 1-tert-amyl peroxy-1-methoxy cyclohexane; tert-butyl peroxyacetate; tert-amyl peroxyacetate; tert-butyl peroxybenzoate; 1,1-di(tert-butylperoxy)-3,3,5-trimethylcyclohexane; 1,1-di(tert-amyl peroxy)-cyclohexane; 1,1-di(1-butylperoxy)-cyclohexane; 2,2-di(tert-butylperoxy)butane; OO-tert-butyl-O-(2-ethylhexyl)-monoperoxycarbonate; OO-tert-amyl-O-(2-ethylhexyl)-monoperoxycarbonate; OO-tert-amyl peroxy-O-isopropyl-monoperoxycarbonate; OO-tert-butylperoxy-O-isopropyl-monoperoxycarbonate; polyether tetrakis(tert-butylperoxycarbonate); or tert-amyl peroxybenzoate.

Preferred room-temperature-stable organic peroxides are: 1-tert-amyl peroxy-1-methoxy cyclohexane (LUPEROX® V10); 1,1-di(t-butylperoxy)-3,3,5-trimethyl cyclohexane (LUPEROX® 231); 1,1-di(tert-butylperoxy)cyclohexane LUPEROX® 331M80; tert-amyl peroxybenzoate (LUPEROX® TAP); tert-butyl peroxybenzoate (LUPEROX® P); 00-tert-butyl-O-(2-ethylhexyl)-monoperoxycarbonate (LUPEROX® TBEC); OO-tert-butylperoxy-O-isopropyl-monoperoxycarbonate (LUPEROX® TBICM75); OO-tert-amyl peroxy-O-isopropyl-monoperoxycarbonate (LUPEROX® TAICM75); OO-tert-amyl-O-(2-ethylhexyl)-monoperoxycarbonate (LUPEROX® TAEC); polyether tetrakis(t-butylperoxycarbonate) (LUPEROX® JWEB-501; tert-amyl peroxyacetate; n-butyl 4,4-di(tert-butylperoxy)valerate (LUPEROX® 230).

More preferred room-temperature-stable organic peroxides are: tert-amyl peroxybenzoate (LUPEROX® TAP); tert-butyl peroxybenzoate (LUPEROX® P); 00-tert-butyl-O-(2-ethylhexyl)-monoperoxycarbonate (LUPEROX® TBEC); OO-tert-butylperoxy-O-isopropyl-monoperoxycarbonate (LUPEROX® TBICM75); 00-tert-amyl peroxy-O-isopropyl-monoperoxycarbonate (LUPEROX® TAICM75); OO-tert-amyl-O-(2-ethylhexyl)-monoperoxycarbonate (LUPEROX® TAEC); and polyether tetrakis(t-butylperoxycarbonate) [LUPEROX® JWEB-50]; 1,1-di-tert-butylperoxy-3,3,5-trimethylcyclohexane; 1,1-di-tert-amyl peroxy hexane (LUPEROX® 531M80) 1,1-di(tert-butylperoxy)cyclohexane LUPEROX® 331M80; and 2,2-di(tert-aryl peroxy)butane LUPEROX® 520.

Even more preferred room-temperature-stable organic peroxides are: tert-amyl peroxybenzoate (LUPEROX® TAP); tert-butyl peroxybenzoate (LUPEROX® P); OO-tert-butyl-O-(2-ethylhexyl)-monoperoxycarbonate (LUPEROX® TBEC); OO-tert-amyl-O-(2-ethylhexyl)-monoperoxycarbonate (LUPEROX® TAEC); 1,1-di-tert-butylperoxy-3,3,5-trimethylcyclohexane LUPEROX® 231; 1,1-di(tert-butylperoxy)cyclohexane LUPEROX® 331M80; and 1,1-di-tert-amyl peroxy hexane (LUPEROX® 531M80).

The other type of organic peroxide is non-room-temperature-stable organic peroxide which is in liquid form at 10° C. or less. These peroxides are not stable at room temperature in liquid form and are stored below room temperature, either in a refrigerator or freezer. These less thermally stable organic peroxides have lower 1 hour and 10 half-life temperatures than the room temperature-stable organic peroxides that are included in the composition, and thus require controlled temperature refrigerated or freezer storage. For example, these non-room-temperature-stable organic peroxides have a 1 hour half-life temperatures of less than 100° C., or less than 98° C., or less than 95° C. or less than 90° C., or less than 88° C., or less than 75° C. These non-room-temperature-stable peroxides may have a 10 hour half-life temperature of 78° C. or less, 75° C. or less, 70° C. or less, 60° C. or less. The most preferred non-room-temperature-stable peroxides have a 1 hour half-life of from less than 96° C. to more than 85° C. and 10 hour half-life temperatures from less than 78° C. to more than 65° C. According to some embodiments “non-room-temperature-stable” organic peroxides may have a recommended maximum storage temperature not to exceed 10° C. or not to exceed 5° C. or lower for six month long term storage.

For example, tert-butylperoxy-2-ethylhexanoate (LUPEROX® 26) has a recommended maximum storage temperature of 50° F. (10° C.) in its original container to maintain no more than 2% loss in peroxide concentration for six months. Trigonox® 421 (1,1,3,3-tetramethylbutylperoxy-2-ethylhexanoate) has a maximum storage temperature of 41° F. (5° C.) to maintain no more than 2% loss of peroxide concentration of the organic peroxide for six months. Thus, the various non-room-temperature-stable organic peroxides may have a maximum recommended storage temperatures of 16° C. or less, or 10° C., or 5° C., or 0° C., or −5° C., or −10° C., or −15° C. or less, depending on the organic peroxide. According to certain aspects of the disclosure, the non-room-temperature-stable organic present in the curable resin composition may have a ten hour half-life temperature of 77° C. or less, or 75° C., or 65° C., or 60° C., or 55° C., or 50° C. or less. According to still further aspects, the non-room-temperature-stable organic peroxides exhibit not more than 2% loss in peroxide concentration after being stored for 3, or 6, or 9 or more months at 10° C. or less.

According to some embodiments, the preferred non-room-temperature-stable organic peroxides have a ten hour half-life temperature range of 78° C. or less to 69° C. or less, with a one hour half-life range of 95° C. or less to 88° C. or less. According to some embodiments, the non-room-temperature storage liquid peroxides may have maximum storage temperature ranging from less than or equal to 16° C. to less than or equal to 5° C.

Non-limiting examples of suitable classes of liquid non-room-temperature-stable organic peroxide formulations that require freezer storage (less than 0° C.) are the peroxydicarbonate class and the peroxyester class of peroxide.

Non-limiting examples of suitable non-room-temperature-stable organic peroxide formulations that require liquid refrigerated storage (greater than 0° to less than 20° C.) are the diacyl class and the peroxyester class of organic peroxide.

Non-limiting examples of suitable non-room-temperature liquid organic peroxides are di(n-propyl) peroxydicarbonate; di(sec-butyl) peroxydicarbonate; di(2-ethylhexyl peroxydicarbonate; 3-hydroxy-1,1-dimethylbutyl peroxyneodecanoate; 1,1-di(t-butylperoxy)-cyclohexane; tert-butyl peroxy-2-ethylhexanoate; α-cumyl peroxyneodecanoate; tert-amyl peroxyneodecanoate; tert-butyl peroxyneodecanoate; tert-amyl peroxypivalate; tert-butyl peroxypivalate; 2,5-di(2-ethylhexanoylperoxy)-2,5-dimethylhexane; tert-amyl peroxy-2-ethylhexanoate; tert-butyl peroxy-2-ethylhexanoate; tert-amyl peroxy-2-ethylhexanoate (LUPEROX® 575); tert-butylperoxy-2-ethylhexanoate (LUPEROX® 26); 2,5-di(2-ethylhexanoylperoxy)-2,5-dimethylhexane (LUPEROX® 256); 1,1,3,3-tetramethylbutylperoxy-2-ethylhexanoate (Trigonox® 421); tert-hexyl peroxy-2-ethylhexanoate; 2-butanone peroxide (LUPEROX® DDM-9); or liquid form of dibenzoyl peroxide, or combinations thereof.

The non-room-temperature organic peroxyester t-amyl peroxy-2-ethylhexanoate (LUPEROX® 575), tert-butyl peroxy-2-ethylhexanoate (LUPEROX® 26), 2,5-di(2-ethylhexanoylperoxy)-2,5-dimethylhexane (LUPEROX® 256), 1,1,3,3-tetramethylbutylperoxy-2-ethylhexanoate (Trigonox® 421); tert-hexyl peroxy-2-ethylhexanoate; dibenzoyl peroxide in liquid form, or combinations thereof are preferred.

For avoidance of doubt, when dibenzoyl peroxide (also referred to as benzoyl peroxide) is in a liquid form (e.g., dissolved into a suitable solvent), it is classed as a non-room-temperature-stable organic peroxide that has a 1 hour half-life temperature of 91° C. (i.e., less than 100° C.). Dibenzoyl peroxide is only storage stable at 38° C. (i.e., room temperature or higher) in its solid form.

The non-room-temperature-stable organic peroxides tert-amyl peroxy-2-ethylhexanoate (LUPEROX® 575); 1,1,3,3-tetramethylbutylperoxy-2-ethylhexanoate (Trigonox® 421); 2,5-di(2-ethylhexanoylperoxy)-2,5-dimethylhexane (LUPEROX® 256); tert-butylperoxy-2-ethylhexanoate and tert-hexylperoxy-2-ethylhexanoate alone or in combination are more preferred.

The non-room-temperature-stable organic peroxides tert-butylperoxy-2-ethylhexanonate; tert-amyl peroxy-2-ethylhexanoate; and 2,5-di(2-ethylhexanoylperoxy)-2,5-dimethylhexane alone or in combination are the most preferred. The preferred combinations of room-temperature-stable and non-room-temperature-stable peroxides are chosen from the following preferred room-temperature-stable peroxides: tert-amyl peroxybenzoate (LUPEROX® TAP); tert-butyl peroxybenzoate (LUPEROX® P); OO-tert-butyl-O-(2-ethylhexyl)-monoperoxycarbonate (LUPEROX® TBEC); LUPEROX® JWEB-50; 00-tert-amyl-O-(2-ethylhexyl)-monoperoxycarbonate (LUPEROX® TAEC); 1,1-di-tert-butylperoxy-3,3,5-trimethylcyclohexane; 1,1-di-tert-amyl peroxy hexane (LUPEROX® 531M80); and 1,1-di-tert-butylperoxycyclohexane (LUPEROX® 331M80).

The following preferred non-room-temperature-stable peroxides may be chosen from: tert-butylperoxy-2-ethylhexanonate; tert-amyl peroxy-2-ethylhexanoate; 1,1,3,3-tetramethylbutylperoxy-2-ethylhexanoate; and 2,5-di(2-ethylhexanoylperoxy)-2,5-dimethylhexane.

In an embodiment, the non-room-temperature-stable peroxide may be free of a perketal.

In one embodiment, a combination of a room and non-room-temperature-stable peroxide comprises a blend of 1,1-di(tert-butylperoxy)cyclohexane (LUPEROX® 331M80) and tert-amyl peroxy-2-ethylhexanoate (LUPEROX® 575).

In another embodiment, a combination of a room and non-room-temperature-stable peroxide comprises a blend of tert-butyl peroxybenzoate and 2,5-di(2-ethylhexanoylperoxy)-2,5-dimethylhexane.

In another embodiment, a combination of room- and non-room-temperature-stable peroxides comprises a blend of 1,1-di-tert-butylperoxy-3,3,5-trimethylcyclohexane and tert-butylperoxy-2-ethylhexanoate.

In another embodiment, a combination of room- and non-room-temperature-stable peroxides comprises a blend of 1,1-di-tert-butylperoxy-3,3,5-trimethylcyclohexane and tert-amyl peroxy-2-ethylhexanoate.

In another embodiment, a combination of room- and non-room-temperature-stable peroxides comprises a blend of tert-butyl peroxybenzoate and 1,1,3,3-tetramethylbutylperoxy-2-ethylhexanoate.

In yet another embodiment, a combination of room- and non-room-temperature-stable peroxides comprises a blend of tert-butyl peroxybenzoate and tert-butylperoxy-2-ethylhexanonate.

In another embodiment, a combination of room- and non-room-temperature-stable peroxides comprises a blend of tert-butyl peroxybenzoate (LUPEROX® P) and tert-amyl peroxy-2-ethylhexanonate (LUPEROX® 575).

In another embodiment, a combination of room- and non-room-temperature-stable peroxides comprises a blend of tert-amyl peroxybenzoate and tert-butyl peroxybenzoate used in combination with a blend of tert-butylperoxy-2-ethylhexanonate and tert-amyl peroxy-2-ethylhexanoate.

In yet another embodiment, a combination of room- and non-room-temperature-stable peroxides comprises a blend of OO-tert-butyl-O-(2-ethylhexyl)-monoperoxycarbonate and tert-butylperoxy-2-ethylhexanonate.

In yet another embodiment, a combination of room- and non-room-temperature-stable peroxides comprises a blend of OO-tert-butyl-O-(2-ethylhexyl)-monoperoxycarbonate and tert-amyl peroxy-2-ethylhexanonate.

In yet another embodiment, a combination of room- and non-room-temperature-stable peroxides comprises a blend of OO-tert-amyl-O-(2-ethylhexyl)-monoperoxycarbonate and tert-amyl peroxy-2-ethylhexanonate. According to an embodiment, a combination of room- and non-room-temperature-stable peroxides comprises a blend of tert-butyl-peroxybenzoate (LUPEROX® P) with 2,5-dimethyl-2,5-di(2-ethylhexanoyl peroxy)-hexane (LUPEROX® 256).

According to an embodiment, a combination of room- and non-room-temperature-stable peroxides comprises a blend of OO-tert-butyl-O-(2-ethylhexyl)-monoperoxycarbonate (LUPEROX® TBEC) with 2,5-dimethyl-2,5-di(2-ethylhexanoyl peroxy)-hexane (LUPEROX® 256).

According to an embodiment, a combination of room- and non-room-temperature-stable peroxides comprises a blend of tert-butyl-peroxybenzoate (LUPEROX® P) with tert-amyl peroxy-2-ethylhexanoate (LUPEROX® 575).

According to an embodiment, a combination of room- and non-room-temperature-stable peroxides comprises a blend of OO-tert-amyl-O-(2-ethylhexyl)-monoperoxycarbonate (LUPEROX® TAEC) with tert-amyl peroxy-2-ethylhexanoate (LUPEROX® 575).

According to an embodiment, a combination of room- and non-room-temperature-stable peroxides comprises a blend of tert-butyl peroxyacetate (LUPEROX® 7M75) with tert-amyl peroxy-2-ethylhexanoate (LUPEROX® 575).

According to an embodiment, a combination of room- and non-room-temperature-stable peroxides comprises a blend of polyether poly(t-butyl)-peroxycarbonate (LUPEROX® JWEB50) with tert-amyl peroxy-2-ethylhexanoate (LUPEROX® 575).

According to an embodiment, a combination of room- and non-room-temperature-stable peroxides comprises a blend of OO-tert-amyl-O-(2-ethylhexyl)-monoperoxycarbonate (LUPEROX® TAEC) with tert-butyl peroxy-2-ethylhexanoate (LUPEROX® 26).

According to an embodiment, a combination of room- and non-room-temperature-stable peroxides comprises a blend of tert-butyl-peroxybenzoate (LUPEROX® P) with tert-butyl peroxy-2-ethylhexanoate (LUPEROX® 26).

According to an embodiment, a combination of room- and non-room-temperature-stable peroxides comprises a blend of 2-butanone peroxide (LUPEROX® DDM-9) with tert-amyl peroxy-2-ethylhexanoate (LUPEROX® 575).

According to an embodiment, the at least one non-room-temperature-stable organic peroxide comprises at least one of diacyl peroxides, ketone peroxides; hydroperoxides; peroxydicarbonates; peroxyesters; diacylperoxides; di(n-propyl) peroxydicarbonate; di(sec-butyl) peroxydicarbonate; di(2-ethylhexyl peroxydicarbonate; 3-hydroxy-1,1-dimethylbutyl peroxyneodecanoate; α-cumyl peroxyneodecanoate; tert-amyl peroxyneodecanoate; α-cumyl peroxyneodecanoate; tert-butyl peroxyneodecanoate; tert-amyl peroxypivalate; tert-butyl peroxypivalate; 2,5-di(2-ethylhexanoylperoxy)-2,5-dimethylhexane; tert-amyl peroxy-2-ethylhexanoate; 1,1,3,3-tetramethylbutylperoxy-2-ethylhexanoate; tert-hexyl peroxy-2-ethylhexanoate; tert-butyl peroxy-2-ethylhexanoate; a solution of dilauryl peroxide; or a solution of dibenzoyl peroxide; preferably tert-amyl peroxy-2-ethylhexanoate; tert-butyl peroxy-2-ethylhexanoate; tert-hexyl peroxy-2-ethylhexanoate; or 1,1,3,3-tetramethylbutylperoxy-2-ethylhexanoate.

According to yet another embodiment, the at least one non-room-temperature-stable organic peroxide comprises at least one of peroxydicarbonates; peroxyesters; diacyl peroxides; tert-amyl peroxy-2-ethylhexanoate (LUPEROX® 575), tert-butylperoxy-2-ethylhexanoate (LUPEROX® 26); 2,5-di(2-ethylhexanoylperoxy)-2,5-dimethylhexane (LUPEROX® 256), 1,1,3,3-tetramethylbutylperoxy-2-ethylhexanoate (Trigonox® 421); tert-hexyl peroxy-2-ethylhexanoate: a solution of dilauryl peroxide, or a solution of dibenzoyl peroxide.

The curable resin composition desirably contains an amount of organic peroxide in total that is effective to achieve substantially complete curing (polymerization) of the curable resin present in the curable resin composition under the curing conditions selected. Such amount may vary substantially depending upon the organic peroxides selected, the components of the activator system (e.g., the particular metal salt(s) and thiol-functionalized organic compound(s) present and their relative amounts), the reactivity of the curable resin, and the curing profile desired, among other parameters. Generally speaking, however, the curable resin composition may, in various embodiments of the disclosure, be advantageously comprised of at least 0.05%, at least 0.1%, at least 0.15%, at least 0.2%, at least 0.25%, at least 0.3%, at least 0.35%, or at least 0.4% or at least 0.6% by weight or more, in total of organic peroxide based on the weight of curable resin. An advantage of embodiments of the present disclosure is that, due to the accelerating effect of the promoter salt(s) and thiol-functionalized organic compound(s) when used in combination, relatively low amounts of organic peroxide can be used, in at least certain embodiments of the disclosure. Thus, the curable resin composition may include not more than 2%, not more than 1.5%, not more than 1%, by weight in total of organic peroxide based on the weight of curable resin.

According to other embodiments the curable resin composition may include more than 2% by weight in total of organic peroxide based on the weight of curable resin. For example, the curable resin composition may include up to 5% by weight in total of organic peroxide based on the weight of curable resin. According to some embodiments, the curable resin composition may include at most 5, 4.75, 4.5, 4.25, 4, 3.75, 3.5, 3.25, 3, 2.75, 2.5, 2.25, or at most 2% by weight in total of organic peroxide based on the weight of curable resin.

The weight ratio of room-temperature-stable liquid organic peroxides to non-room-temperature-stable liquid peroxides may be varied as may be desired in order to provide the curable resin composition with a target cure profile. For example, such weight ratio of room-temperature-stable to non-room-temperature-stable organic peroxides may be from 4:1 to 1:4; from to 3:1 to 1:3, from 2:1 to 1:2; or may be 1:1; or preferably from 3:1 to 1:1; or from 2:1 to 1:1, or from 1:2 to 1:3; or from 3:1 to 1:4, although higher or lower weight ratios could also be used. For example, the weight ratio of room-temperature-stable to non-room-temperature-stable organic peroxides may be from 10:1 to 1:10; 9:1 to 1:9; 8:1 to 1:8; 7:1 to 1:7; 6:1 to 1:6; 5:1 to 1:5; or from 4:1 to 1:4.

One advantage of the liquid organic peroxide formulations useful in embodiments of this disclosure is that there is no need to dilute the organic peroxide(s)/formulations/blends in styrene in order to prepare a well-dispersed liquid before mixing with the resin and impregnating the substrate to be cured. Accordingly, the liquid organic peroxides, liquid peroxide formulations, and liquid organic peroxide blends, useful in embodiments of this disclosure may comprise less than 30 wt %, less than 20 wt %, less than 10 wt %, less than 5 wt %, less than 3 wt %, less than 2 wt %, less than 1%, less than 0.5%, less than 0.1% or even 0 (zero) wt % styrene based on the total weight of the organic peroxide blend. Elimination of styrene removes the need for separate storage and handling of styrene and extra processing steps and is better for the environment.

### Metal Salts (Accelerator/Activator/Promoter)

One or more metal salts may be present in the curable resin compositions of embodiments of the present disclosure. Such salts, accelerator, or promotor promote or activate the decomposition of one or more of the organic peroxides present in the curable resin composition, thereby accelerating the curing of the curable resin composition by the organic peroxides. Without wishing to be bound by any particular theory, it is believed that such metal salts may react with the thiol-functionalized organic compound(s) also present in the curable resin composition to form complexes which are actually the species responsible for accelerating cure at elevated temperatures, or that the thiol may otherwise assist peroxide decomposition and resin curing.

Suitable metal salts include salts of metals selected from the group consisting of Li, Al, Mg, Co, Fe, Cu, Zn, Ni, Mn, Cr, Sn, Au, Pd and Pt. The anionic portion of the salt may be a halide, nitrate, sulfate, or carboxylate. Other suitable anions are lactate, acetate, hexanoate, or naphthenate, for example. Halide salts of transition metals are preferred. Halide salts, in particular chloride salts, of transition metals are especially preferred.

According to certain embodiments of the disclosure, the at least one metal salt may include at least one transition metal halide. In particularly preferred aspects, the at least one metal salt includes at least one zinc or copper or lithium halide, such as zinc chloride, lithium chloride, or copper (II) chloride. Zinc chloride, lithium chloride, copper(II) chloride or a combination thereof are preferred. Zinc chloride and/or lithium chloride are more preferred. Zinc chloride is a particularly preferred metal salt for use in embodiments of the present disclosure.

Typically, the curable resin composition will include an amount of metal salt effective to reduce the cure time of the curable resin composition as compared to the cure time observed in the absence of metal salt. Such an amount will vary depending upon a number of factors, but in various embodiments of the disclosure metal salt is present in an amount which provides at least 5, 10, 20, 30, 40 or 50 ppm in total of the metal(s) selected from the group consisting of Li, Al, Mg, Co, Fe, Cu, Zn, Ni, Mn, Cr, Sn, Au, Pd, and Pt, based on the weight of curable resin in the curable resin composition. In other embodiments, the curable composition contains metal salt(s) in an amount to provide not more than 500, 400, 300, 200 or 100 ppm of such metal(s) in the curable resin composition, based on the weight of curable resin.

### Thiol-Functionalized Organic Compounds

The curable resin compositions of the present disclosure may include at least one thiol-functionalized organic compound. Such thiol-functionalized organic compounds may be characterized as organic compounds including at least one thiol (—SH) functional group per molecule that are capable of increasing the rate at which the curable resin composition is cured when used in accordance with embodiments of the disclosure. According to certain embodiments of the disclosure, the at least one thiol-functionalized organic compound includes at least one thiol-functionalized organic compound including two or more thiol functional groups per molecule. The thiol group(s) in the thiol-functionalized organic compound in one embodiment of the disclosure may be an aliphatic thiol group or aliphatic thiol groups (wherein each thiol group is attached to an aliphatic carbon atom). In still further embodiments, the thiol group(s) is a primary aliphatic thiol group or are primary aliphatic thiol groups. The at least one thiol-functionalized organic compound may include at least one α-mercaptoacetate or β-mercaptopropionate ester of an alcohol. The alcohol may be a polyalcohol containing two or more hydroxyl groups per molecule, such as a glycol; trimethylolpropane; pentaerythritol; or the like. Illustrative examples of suitable thiol-functionalized organic compounds include dipentene dimercaptan; ethylcyclohexyldimercaptan; ethylene-1,2-bis-3-mercaptoacetate; ethylene-1,2-bis-3-mercaptopropionate; 1,2,3-propanetrithiol; 1,2,6-hexanetrithiol; pentaerythntolthiol; pentaerythritol tetrakis(2-mercaptoacetate); pentaerythritol tetrakis(3-mercaptopropionate); trimethylol propanetris(3-mercaptopropionate); 1,1,1-propanetriyl tris(mercaptoacetate); and thiolic derivatives of the formula: R—(R′—CH(OH)—CH₂—SH)ₙ wherein R is a linear alkyl group having 3-30 carbon atoms, R′ is a linear alkylene group having 3-30 carbon atoms and n is an integer of 2-6. Thiol-functionalized organic compounds suitable for use in embodiments the present disclosure also include any of the thiolic compounds disclosed in U.S. Pat. No. 5,310,826, the entire disclosure of which is incorporated herein by reference for all purposes. Combinations of two or more different thiol-functionalized organic compounds may be used.

Most preferred thiol-functionalized organic compounds include trimethylolpropane tris(3-mercaptopropionate); pentaerythritol tetrakis(2-mercaptoacetate); pentaerythritol tetrakis(3-mercaptopropionate); and 1,1,1-propanetriyl tris-(mercaptoacetate). Of these, the pentaerythritol tetrakis(3-mercaptopropionate) is even more preferred.

The amount of thiol-functionalized organic compound present in the curable resin composition may be varied as desired or needed depending upon the activity of the thiol-functionalized organic compound(s), the type and reactivity of the other components of the curable resin composition, the cure profile desired, and other factors. However, generally speaking, the curable resin composition may include at least 0.005%, at least 0.01% or at least 0.02% by weight but not more than 2%, not more than 1% or not more than 0.5% by weight, in total, of thiol-functionalized organic compound, based on the weight of curable resin in the curable resin composition.

The weight ratio of metal salt to thiol-functionalized organic compound may be varied as appropriate or desired depending upon a number of factors, including the particular metal salt(s) and thiol-functionalized organic compound(s) used and the target cure profile of the curable resin composition. According to certain non-limiting aspects of the disclosure, however, this weight ratio may vary from 1:1 to 1:10.

### Solvent

The curable resin compositions of embodiments of the present disclosure may additionally include at least one solvent. Nonlimiting examples of suitable solvents are alcohols, glycols, or glycol ethers.

Suitable alcohols are alkyl mono alcohols having from 1 to 30 carbon atoms. Non-limiting examples of suitable alcohols are tert-butyl alcohol, tert-amyl alcohol, ethyl alcohol, or isopropyl alcohol.

Non-limiting examples of suitable glycols are ethylene glycol, propylene glycol, butylene glycol, dipropylene glycol, diethylene glycol, triethylene glycol, neopentyl glycol, pentaerythritol, or combinations thereof. Dipropylene glycol is preferred. As mentioned above, these glycols may be capable of reacting with certain of the curable resin systems.

Nonlimiting examples of suitable glycol ethers are methoxyethanol, ethoxyethanol, butoxyethanol, methoxypropanol, diethyleneglycol monobutyl ether (DGMBE), or combinations thereof. Glycol ethers are preferred solvents in the curable resin compositions and diethyleneglycol monobutyl ether (DGMBE) is most preferred.

### Other Components

The above-mentioned curable resins, peroxides, promoter salts, and thiol-functionalized organic compounds can be combined with any of the other additives conventionally used in the cured-resin art, such as fillers, fibers, pigments, phlegmatizers, inhibitors (e.g., inhibitors of oxidative, thermal and/or ultraviolet degradation), lubricants, thixotropic agents, co-agents and promoters.

Examples of suitable fibers include glass fibers, carbon fibers, polymeric fibers (e.g., aramid fibers), natural fibers and the like and combinations thereof. The fibers may be in any suitable form, including in the form of mats, tows and other such forms known in the art.

Examples of suitable fillers include talc, calcium carbonate, quartz, sand, silica, aluminum trihydroxide, magnesium hydroxide, chalk, calcium hydroxide, clays, carbon black, titanium dioxide and lime, as well as organic fillers such as thermoplastics and rubbers, and mixtures of any of these.

In one embodiment, the disclosure is directed to an organic peroxide composition comprising a blend of:
non-room-temperature-stable organic peroxide;
room-temperature-stable organic peroxide;
at least one transition metal halide salt dissolved in an alcohol, glycol or glycol ether;
at least one thiol-functionalized organic compound;
wherein said organic peroxide composition is room temperature stable for at least 1, 2, 3, 4, 5, 6, 7, 8, 10, 12, 14, or up to 24 hours.

In another embodiment, the disclosure is directed to an organic peroxide composition comprising a blend of a non-room-temperature-stable peroxide which is tert-amyl peroxy-2-ethylhexanoate LUPEROX® 575 or 1,1,3,3-tetramethylbutylperoxy-2-ethylhexanoate (Trigonox®, 421); a room-temperature-stable-peroxide which is tert-butyl peroxybenzoate LUPEROX® P; a metal halide which is a Zn halide, preferably ZnCl₂, dissolved in a glycol ether, preferably dissolved in diethylene glycol mono butyl ether; and a thiol compound, which preferably is pentaerythritol tetrakis(3-mercaptopropionate). The organic peroxide composition of this embodiment is room temperature stable for at least 1, 2, 3, 4, 5, 6, 7, 8, 10, 12, 14, or up to 24 hours.

### Formulation of Curable Resin Compositions

Preparation of the curable resin compositions in accordance with embodiments of the present disclosure may be carried out using any suitable method. For example, at least one curable resin; at least one room-temperature-stable organic peroxide, which is liquid at 25° C.; at least one liquid non-room-temperature-stable peroxide which is liquid at 10° C.; at least one salt of at least one metal including at least one of Li, Al, Mg, Co, Fe, Cu, Zn, Ni, Mn, Cr, Sn, Au, Pd and Pt; at least one thiol-functionalized organic compound; and optionally at least one solvent including at least alcohol, glycol or glycol ether, may be combined at about room temperature (e.g., 20° C. to 30° C.) to form a liquid and/or flowable curable resin composition, which is thereafter heated to a temperature effective to cure the curable resin composition.

Alternatively, it is also possible to pre-mix certain of the ingredients of the curable resin composition to provide separate storage-stable components, which are then combined when it is desired to prepare the curable resin composition and to use the curable resin composition to produce a cured composition from the curable resin composition.

For example, one embodiment of the present disclosure provides a system useful as a curing system for a curable resin. Such a system may include a first component and a second component. The first component may include at least one room-temperature-stable organic peroxide, which is in liquid form at 25° C. and has a one-hour half-life temperature of 100° C. or more; and at least one non-room-temperature-stable peroxide which is in liquid form at 10° C. or less, and has a one-hour half-life temperature of less than 100° C., and which is optionally substantially devoid of styrene or is optionally devoid of styrene. The second component may include at least one salt of at least one metal selected from the group consisting of Li, Al, Mg, Co, Fe, Cu. Zn, Ni, Mn, Cr, Sn, Au, Pd and Pt; at least one thiol-functionalized organic compound; and, optionally, at least one solvent including at least one of alcohols, glycols, or glycol ethers. The second component may be formulated in the form of a solution or dispersion, wherein a solvent or dispersant or combination of solvent or dispersants is used to dissolve the promoter salt(s) and the thiol-functionalized organic compound(s). To prepare a curable resin composition, the first component and second component are combined with a third component including at least one curable resin in the desired proportions.

In another embodiment of the present disclosure, the curable resin(s), metal salt(s), and thiol-functionalized organic compound(s), are pre-mixed days or weeks before the addition of the peroxides to form a curable resin composition and, consequently, the start of the actual curing process. This allows the commercial-scale production and sale of a composition which already contains a metal salt/thiol system and which only needs to be combined with the peroxides as described herein to provide the curable resin composition of an embodiment of the present disclosure.

In yet another embodiment, a curing system including at least one room-temperature-stable organic peroxide, which is liquid at 25° C. and has a 1 hour half-life temperature of 100° C. or more; and at least one non-room-temperature-stable peroxide which is in liquid form at 10° C. or less, and has a 1 hour half-life temperature less than 100° C.; at least one salt of at least one metal selected from the group consisting of Li, Al, Mg, Co, Fe, Cu. Zn, Ni, Mn, Cr, Sn, Au, Pd and Pt; at least one thiol-functionalized organic compound; and, optionally, at least one solvent including at least one of alcohols, glycols, or glycol ethers is provided. This system is storage-stable even though it contains both peroxides, the thiol compound, and the metal salt in a single composition.

Another embodiment of the disclosure is a curing system including at least one room-temperature-stable organic peroxide, which is liquid at 25° C. and has a one-hour half-life temperature of 100° C. or more; and at least one non-room-temperature-stable peroxide which is in liquid form at 10° C. or less, and has a one-hour half-life temperature of less than 100° C.; at least one salt of at least one metal selected from the group consisting of Li, Al, Mg, Co, Fe, Cu, Zn, Ni, Mn, Cr, Sn, Au, Pd, and Pt; at least one thiol-functionalized organic compound; and, at least one solvent including at least one of alcohols, glycols, or glycol ethers is provided, where glycol ether type solvent is preferred. This system is storage-stable even though it contains both peroxides, the thiol compound, the metal salt, and at least one of alcohols, glycols, or glycol ethers in a single composition.

In another embodiment, a combination of room- and non-room-temperature-stable peroxides comprises a blend of tert-butyl peroxybenzoate (LUPEROX® P), tert-amyl peroxy-2-ethylhexanonate (LUPEROX® 575), ZnCl₂, PETMP (pentaerythritol tetrakis(3-mercaptopropionate) and diethylene glycol monobutyl ether (DGMBE) as an optional solvent.

Also contemplated by embodiments of the present disclosure are two-component systems including a first component and a second component, wherein the first component includes at least one pre-accelerated curable resin (a combination of at least one curable resin, at least one metal salt, and at least one thiol-functionalized organic compound) and the second component includes a mixture of the different organic peroxides used in embodiments of the present disclosure. This second component may include the metal salts, the thiol compound and the solvent as disclosed herein, in addition to the room-temperature-stable peroxide and the non-room-temperature-stable peroxide. As used herein, the term “two-component system” refers to systems where two components (A and B) are physically separated from each other (for instance, in separate cartridges, compartments, totes, drums or other containers), wherein components A and B are physically combined (admixed) at the time the system is to be used to form a cured resin.

In particularly preferred embodiment of the disclosure, a curing system is provided which includes:
i) a first component including:
   at least one room-temperature-stable organic peroxide which is in liquid form at 25° C. and has a 1 hour half-life temperature of 100° C. or more; and
   at least one non-room-temperature-stable organic peroxide which is in liquid form at 10° C. or less, and has a one-hour half-life temperature of less than 100° C.; and
ii) a second component including:
   at least one salt of at least one metal including at least one of Li, Al, Mg, Co, Fe, Cu, Zn, Ni, Mn, Cr, Sn, Au, Pd, or Pt;
   at least one thiol-functionalized organic compound; and
   optionally at least one solvent including at least one of alcohols, glycols, or glycol ethers.

The first component optionally may be devoid of styrene.

### Uses of Curable Resin Compositions

The curable resin compositions of embodiments of the present disclosure are particularly useful in applications in which it is desired to have an extended open time at ambient temperatures (e.g., room temperature or 25° C.) but a relative short cure time once the curable resin composition is heated to an elevated temperature (e.g., at least 50° C., 60° C., 70° C. or 80° C. but typically not more than 250° C., 240° C., 230° C., 220° C., 210° C. or 200° C.). In various embodiments of the disclosure, the curing time (i.e., the time during which the curable resin composition is heated) is at least 0.5, 1, 2, 3, 4 or 5 minutes but not more than 10 hrs., 9, 8, 7, 6, 5, 4, 3, 2, 1 hr., or 0.5 hours. For example, the curable resin composition may be heated for 1 minute to 20 minutes. Heating of the curable resin composition may be carried out at a temperature and for a time effective to achieve at least 95%, 96%, 97%, 98%, 99%, 99.5%, 99.9%, 99.99%, or even 100% reaction of the monomer initially present in the curable resin. The percent reaction of the monomer may be calculated by analytically measuring the residual unreacted monomer remaining in the cured resin as a percentage of the total composition formulation.

Such applications include, for example, composite systems in which a matrix (such as a matrix of fibers, such as glass, polymeric or carbon fibers, in sheet or tow form, for instance) is impregnated with a curable resin composition to form an impregnated matrix, the impregnated matrix then being formed into a desired configuration and cured to provide a composite article.

For example, the curable resin compositions of embodiments of the present disclosure may be utilized in so-called “cured-in-place” pipe systems. A cured-in-place pipe (CIPP) is one of several trenchless rehabilitation methods used to repair existing pipelines, such as water, sewer, gas and chemical pipelines. CIPP is a jointless, seamless, pipe-within-a-pipe with the capability to rehabilitate pipes of varying diameter and configurations, which avoids having to dig up an existing pipeline in order to repair or replace it. In the context of the present disclosure, a flexible liner including polyester fabric, fiberglass cloth or other type of fabric (woven or non-woven) may be impregnated with the curable resin composition to provide a resin-impregnated liner, which is then inverted or pulled into a damaged pipe (as described, for example, in U.S. Pat. Nos. 4,009,063 and 4,064,211, the entire disclosure of each of which is incorporated herein by reference for all purposes). The liner may be in the form of a laminate, comprised of a layer of a non-woven fabric coated with a thermoplastic sheet material, wherein the non-woven fabric has been impregnated with the curable resin composition. The resin-impregnated liner may be inverted using water or air pressure. Once positioned within the damaged pipe, the resin-impregnated liner may be heated by any suitable method to a temperature effective to initiate curing of the curable composition. For example, hot water or steam may be introduced into the resin-impregnated liner in place within the damaged pipe to provide heat. In certain cases, the ambient temperature within the damaged pipe containing the resin-impregnated liner may be sufficiently high so as to achieve the desired curing. Once cured, the resin-impregnated liner becomes relatively hard and rigid, and thus capable of functioning as a pipe for transport of liquids, gases and the like. The long open times characteristic of the curable resin compositions of embodiments of the present disclosure provide a distinct advantage in such cured-in-place pipe systems, as the resin-impregnated liner remains flexible and workable over an extended period of time and allows the resin-impregnated liner to be prepared well in advance of its actual deployment provided it is maintained at a temperature below the temperature at which curing of the curable resin begins to occur at a significant rate. Although the resin-impregnated liner may be refrigerated to even further extend its open time, in certain embodiments of the disclosure such refrigeration is not necessary due to the curable resin composition having an adequate open time (e.g., 15-, 30-, 45-, 60 minutes or more) even at ambient temperatures of 20-25° C.

Accordingly, an embodiment of the present disclosure includes a resin-impregnated liner comprised of a liner impregnated with a curable resin composition in accordance with any of the embodiments described herein. A further embodiment of the disclosure provides a process of making a resin-impregnated liner suitable for use in a cured-in-place pipe method, wherein the process includes impregnating a liner with a curable resin composition in accordance with any of the embodiments described herein. Also provided by an embodiment of the present disclosure is a method for lining a cavity of a passageway or pipe having an inner surface including a) introducing a resin-impregnated liner into the cavity, wherein the resin-impregnated liner is comprised of a liner impregnated with a curable resin composition in accordance with any of the embodiments described herein and b) introducing steam or hot water into an inner opening of the resin-impregnated liner to force the resin-impregnated liner against the inner surface of the passageway or pipe and to activate curing of the curable resin composition present in the resin-impregnated liner. The resin-impregnated liner is initially flexible, but then is cured to a hard state within the passageway or pipe.

The curable resin compositions of embodiments of the present disclosure are also useful in a pultrusion process. As is well known in the art, pultrusion is a combination of a pulling and an extrusion process. A reinforcement structure, which may be fibers, cloth, or other forms, is continuously pulled from spools or the like and impregnated with a matrix material, which in the context of the present disclosure may be the curable resin material described herein. Such impregnation may be performed in a wet bath, for example. The combined curable resin composition-impregnated reinforcement structure is formed into its final shape by pulling it through a heated die. The final curing of the composite generally also occurs in the downstream portion of the die. The long open times but short cure times of the curable resin composition of embodiments of the present disclosure make it particularly well suited for use in such a pultrusion process.

One exemplary embodiment of such a pultrusion process may be described generally as follows. Reinforcing material in fiber form is maintained on racks or spindles or other suitable support. The fiber strands may pass through preforming guides to associate the fibers in a preliminary grouping, or the fibers may be pre-associated so as to form woven or braided strands. A tank is provided which holds a volume of the curable resin composition in liquid form (as a resin bath), wherein the curable resin composition is maintained at a temperature at which curing does not take place at a significant rate. A reinforcement material such as a tow formed from the fiber strands is drawn through the resin bath and curable resin composition soaks into the reinforcement material. The wetted tow may be drawn through rollers and a second material guide, which further shapes the composite. The composite tow is shaped within a pultrusion die, where it is also cured by action of one or more heaters. Composite products capable of being manufactured by a pultrusion method include, for example, ladder components, door and window profiles, structural members, cable trays, tool handles, pipe; tubing; rebar; wind turbine blade components, panels; and the like.

In addition to the processes described above, curable resin compositions of embodiments of the present disclosure are also useful in a resin transfer molding process. As well known in the art, resin transfer molding consists of a process where a reinforcing material, such as a fiber mat, matrix or pre-form, is placed in matched mold tooling. The tooling is closed and curable resin is injected into the gap, infusing the reinforcing material. The tooling is generally heated and cure is initiated at elevated temperature and under compression of the tooling. A further explanation of conventional resin transfer molding appears in U.S. Pat. No. 4,762,740, which is incorporated herein by reference in its entirety for all purposes. In one type of resin transfer molding, one of the mold halves is a flexible bag or sheet known as a vacuum bag.

One exemplary embodiment of such a resin transfer molding process may be described generally as follows. Reinforcing material in woven fiber form is draped in the matched mold tooling or inserted as a pre-form. The tooling is closed and curable resin is injected into the gap, either in the form of a fully preformulated resin, or after mixing multiple components at the point of injection. The heated tooling compresses the resin/reinforcement system and cure occurs. The tooling is opened, the cured part is removed and the process is repeated.

The curable resin compositions of embodiment of the present disclosure are also useful in the fabrication of prepreg sheets, tapes or fabrics, wherein a matrix of fibers (glass fibers, polymeric fibers, carbon fibers, etc., in non-woven or woven form) is impregnated with the curable resin composition. Multiple layers of curable resin composition-impregnated fiber matrix may then be arranged or stratified so that the fibers in the individual layers are aligned in the same or different direction, then molded and cured by pressing or other type of compacting while heating to form a cured composite article.

Within this specification, embodiments have been described in a way which enables a clear and concise specification to be written, but it is intended and will be appreciated that embodiments may be variously combined or separated without departing from the disclosure. For example, it will be appreciated that all preferred features described herein are applicable to all aspects of the disclosure.

In some embodiments, the disclosure can be construed as excluding any element or process step that does not materially affect the basic and novel characteristics of the composition or process. Additionally, in some embodiments, the disclosure can be construed as excluding any element or process step not specified herein.

Although the disclosure is illustrated and described herein with reference to specific embodiments, the disclosure is not intended to be limited to the details shown. Rather, various modifications may be made in the details within the scope and range of equivalents of the claims and without departing from the disclosure.

### EXAMPLES

The following materials were used in the Examples.
Base resin: UPR (unsaturated polyester resin) Aropol® 2036C (an isophthalic resin from Ashland).
PETMP: pentaerythritol tetrakis(3-mercaptopropionate).
LUPEROX® 575: tert-butyl peroxy-2-ethyl hexanoate (Arkema). (Non-room-temperature-stable)
LUPEROX® M520M50: 2,2-di(tert-amyl peroxy)butane (Arkema) (Room-temperature-stable)
LUPEROX® 331M80: 1,1-di(tert-butyl peroxy)cyclohexane (Arkema)(Room-temperature-stable)
LUPEROX® 531M80: 1,1-di(tert-amyl peroxy)cyclohexane (Arkema) (Room-temperature-stable)
LUPEROX® P: tert-butyl perbenzoate (Arkema). (Room-temperature-stable)
LUPEROX® TBEC: tert-butyl peroxy-2-ethylhexyl carbonate (Arkema) (Room-temperature-stable)
DGMBE: Diethylene Glycol Mono Butyl Ether
ZnCl₂: Zinc Chloride
LiCl: Lithium Chloride
UPR: Unsaturated Polyester Resin

### Example 1: Non-Room-Temperature-Stable Peroxide Combined with Room-Temperature-Stable Peroxides

The formulation including tert-butyl peroxy-2-ethyl hexanoate (LUPEROX® 575), zinc chloride (ZnCl₂) and pentaerythritoltetramercaptopropionate (PETMP) in an uncured base resin as shown in Table 1 was prepared.

TABLE 1

| | grams | Wt % |
|---|---|---|
| UPR Base resin | 175 | 99.76% |
| PETMP | 0.0525 | 0.03% |
| ZnCl₂ | 0.0119 | 0.01% |
| LUPEROX ® 575 | 0.35 | 0.20% |
| Total | 175.41 | 100.00% |

In Table 1 a blend of the UPR base resin combined with PETMP (a thiol functionalized organic compound) and a ZnCl₂ to which was added 0.20 wt % of LUPEROX® 575 (a non-room-temperature organic peroxide). Using this composition of Table 1 as a stock solution, portions of this resin composition of Table 1 were used to create several different non-room-temperature organic peroxide and a room-temperature peroxide combinations, as per Table 2.

Thus, the formulation shown in Table 1 containing a non-room-temperature organic peroxide was combined with various additional room-temperature-stable organic peroxides as shown in Table 2. The amounts of each room-temperature-stable peroxide was added to the resin to provide a final 0.20 wt % (pure peroxide basis) concentration correcting for any solvent in the peroxide formulation. For example, LUPEROX® 520M50 is a room-temperature-stable peroxide that is diluted to 50 wt % in mineral spirits. Thus 0.4 wt % of the LUPEROX® 520M50 peroxide formulation was required to provide 0.2 wt % (pure peroxide basis). See Table 2

TABLE 2

| | | Grams of | | |
|---|---|---|---|---|
| | | Room-Temp. | | Wt % of Room- |
| Grams of | | peroxide added | Wt % of Room- | Temp. peroxide |
| Table 1 | Room-Temp. | to 25 g from | Temp. peroxide | (pure peroxide |
| Composition | Peroxide | Table 1 | added | basis) |
| 25 | None (only | 0.000 | 0.00% | 0.00% |
| | contains | | | |
| | LUPEROX ® | | | |
| | 575) | | | |
| 25 | LUPEROX ® P | 0.050 | 0.20% | 0.20% |
| 25 | LUPEROX ® | 0.0625 | 0.25% | 0.20% |
| | 331M80 | | | |
| 25 | LUPEROX ® | 0.100 | 0.40% | 0.20% |
| | 520M50 | | | |
| 25 | LUPEROX ® | 0.050 | 0.20% | 0.20% |
| | TBEC | | | |
| 25 | LUPEROX ® | .0625 | 0.25% | 0.20% |
| | 531M80 | | | |

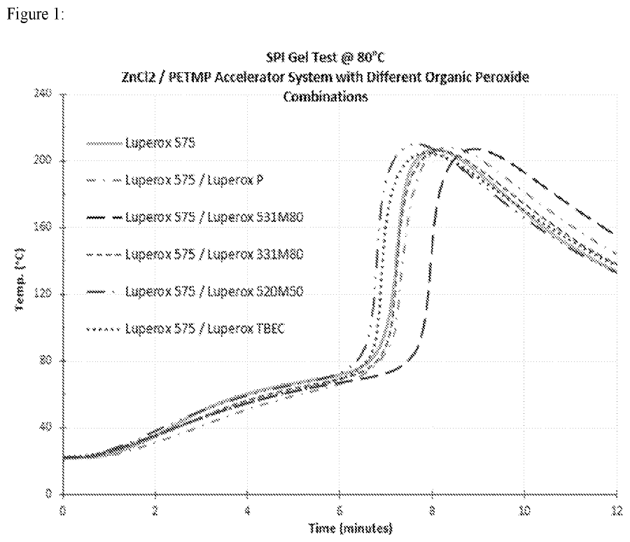

The organic peroxide blends added to the resin shown in Table 2 were cured and the exotherm temperatures monitored to observe the cure rate. The UPR resins with the various peroxide blends in Table 2 were subjected to a standard SPI gel test in an oil bath at 80° C. and the cure results for the various organic peroxides are plotted in FIG. 1.

It is important to note that all the of peroxides in Table 2, including the singular use of Luperox® 575 were blended with a novel accelerator system of an embodiment of this disclosure, provided in Table 1. Due to the use of the accelerator solution, all of the peroxides shown in FIG. 1, including the singular use of Luperox® ~575 resulted in a much faster cure profile (versus when not using the accelerator solution).

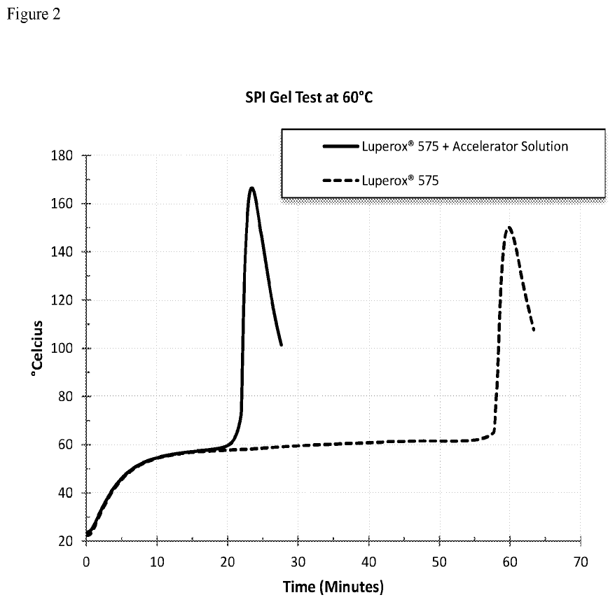

Without the accelerator solution, even the fast curing non-room temperature (refrigerated) peroxide Luperox® 575 cures slower. This can be seen in FIG. 2. For example: When performing a 60° C. gel test Luperox® 575 (a non-room temperature stable peroxide) without any accelerator solution, the time to the peak exotherm is very long and is not achieved until the 60 minute mark.

In contrast when Luperox® 575 is mixed with our accelerator solution and tested at 60 C, the time to the peak exotherm is much quicker and is reached in only 23 minutes, as shown in Example 2, FIG. 2.

Quite unexpectedly, referring to FIG. 1, using a more thermally stable (room-temperature-stable organic peroxides) combined with LUPEROX® 575 (non-room-temperature-stable organic peroxide)resulted in a more desirable, faster to equivalent exotherm cure profile when curing UPR resin with zinc chloride metal salt and the PETMP thiol functionalized organic compound; versus the singular use of the less thermally stable LUPEROX® 575. Specifically, referring to FIG. 1, blends of [LUPEROX® TBEC & LUPEROX® 575]; and [LUPEROX® 520 & LUPEROX® 575] unexpectedly provided a desirable faster cure profile than the singular use of LUPEROX® 575. Note: LUPEROX® TBEC and LUPEROX® 520 are slower, more thermally stable, ROOM TEMPERATURE STABLE PEROXIDES. This result is highly unexpected, because the singular use of non-room-temperature-stable peroxide (LUPEROX® 575) would be expected to cure much faster, versus when Luperox® 575 is blended with much slower, ROOM TEMPERATURE stable peroxides.

The blends of [LUPEROX® P & LUPEROX® 575]; and [LUPEROX® 331M50 & LUPEROX® 575] provided equivalent cure initiation time, but with an unexpected and desirable higher extended cure exotherm after the 8 minute mark of the peak exotherm, compared to the singular use of LUPEROX® 575. A higher extended exotherm would help to provide a more complete cure.

The blends of [LUPEROX® 575 & LUPEROX® 531M80] provided a peak exotherm at ~9 minutes, which is one minute slower than the singular use of Luperox® 575 with the same accelerator system. However it is important to note that the blend of [LUPEROX® 575 & LUPEROX® 531M80] mixed with our accelerator system still provided a much faster cure than when NOT using our novel accelerator solution system.

### Example 2: Singular Use of Luperox® 575 (a Non-Room Temperature Organic Peroxide) with and without Our Novel Accelerator System

This illustrates how our novel accelerator system can accelerate the cure of an unsaturated polyester resin (UPR) at 60° C. containing the singular use of Luperox® 575 versus no accelerator solution. Please refer to FIG. 2. Performing a 60° C. gel test, Luperox® 575 (a non-room temperature organic peroxide) provides a peak exotherm at 60 minutes without any accelerator solution. However, when Luperox® 575 is mixed with an accelerator solution of an embodiment of the disclosure and tested at 60° C. the peak exotherm is achieved in only 23 minutes. The comparison graph is provided in FIG. 2.

TABLE 3

Percentage

| | 1 | 2 |
|---|---|---|
| UPR | 97.6 | 98 |
| Luperox ® 575 | 2 | 2 |
| Accel. Soln | 0.4 | |
| Total= | 100 | 100 |

Notes:
The accelerator solution is comprised of 86.5 wt % DGMBE, 11 wt % PETMP, and 2.5 wt % ZnCl2

### Example 3: Organic Peroxide Blend that Includes a Transition Metal Salt and a Thiol Functional Organic Compound

This example illustrates the novelty of our accelerator solution. We teach in this example, that it is possible to unexpectedly produce a safe one part solution comprising an organic peroxide combined with an accelerator solution of an embodiment of the disclosure. Producing a safe one-part solution of an organic peroxide containing an accelerator solution is highly unusual and is highly unexpected and incredibly novel. One of normal skill in the art knows it is extremely unsafe to add any accelerator system directly into an organic peroxide, as a spontaneous and very dangerous decomposition of the organic peroxide would be expected to occur. Thus being able to make a safe solution of organic peroxide containing an accelerator solution is very novel and provides customers with a measure of safety knowing that if the accelerator blend is accidently mixed with the organic peroxide, a violent decomposition will not occur.

A room temperature stable mixture comprising a non-room-temperature-stable peroxide, a room-temperature-stable peroxide along with the accelerator system of an embodiment of the disclosure comprising a blend of DGMBE, ZnCl₂ and PETMP was produced.

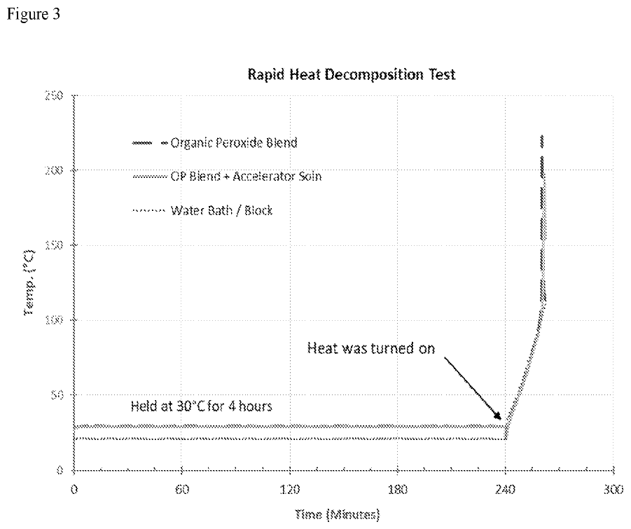

FIG. 3 compares the 30° C. elevated temperature stability of a (2:1) wt ratio blend of tert-butyl peroxybenzoate (Luperox® P, a room-temperature-stable organic peroxide) and tert-amyl peroxy-2-ethylhexanoate (Luperox® 575, a non-room-temperature-stable organic peroxide). This blend of peroxides was evaluated with and without our novel accelerator solution. (Note: Unsaturated polyester resin was not used in this example). The accelerator solution used in the practice of embodiments of the disclosure was added directly to the organic peroxide formulation at ambient conditions, which is unusual because one of normal skill in the art would expect rapid peroxide decomposition. Furthermore, continued unexpected stability (non-decomposition) at an elevated temperature was seen even when holding this peroxide composition plus accelerator package in a 30° C. water bath for four hours.

Specifically, two glass test tubes were prepared by adding to each test tube 0.9 grams total weight of a peroxide blend. This blend was a 2:1 wt ratio of tert-butylperoxybenzoate to tert-amyl peroxy-2-ethylhexanoate. In one of these test tubes 0.15 grams of an accelerator solution was also added. This accelerator blend solution composition consisted of 86.5% DGMBE, 11% PETMP, and 2.5% ZnCl2. The accelerator solution was added directly to the pure peroxide blend. Quite surprisingly neither a reaction nor an immediate decomposition occurred at the ambient laboratory temperature of 73° F. (22.7° C.). This was extremely unexpected. One of normal skill in the art would have expected an immediate peroxide decomposition.

To further study the blend of peroxides, with and without accelerator solution, both test tubes were placed in a water bath set to 30° C. (86° F.) and held at that elevated temperature for 4 hours. The results in FIG. 3 do not show any visible signs of peroxide decomposition for the blend of peroxide without any accelerator solution as well as the blend of peroxide with the accelerator solution. This data shows that the novel accelerator solution when added to the peroxide blend had unexpectedly the same thermal stability as the peroxide blend without any accelerator solution. Thus this data shows that we can create an unexpectedly safe one-part solution of organic peroxides plus our novel accelerator solution.

Additionally, after four hours at 30° C., these two solutions were removed from the water bath and then placed in a heating block. The heating block was ramped up in temperature at a rate of 4° C. per minute. Referring to FIG. 3, it shows that the exotherms for both solutions were similar indicating that the organic peroxide blend with the accelerator solution is still viable.

In summary, good thermal stability along with good peroxide decomposition performance at elevated temperatures was demonstrated for the room-temperature-stable and non-room-temperature-stable organic peroxide blend that contained our novel accelerator solution. We have demonstrated that a blend of the non-room-temperature-stable plus room-temperature-stable peroxide blend further blended with an accelerator solution of embodiments of the disclosure was unexpectedly just as stable as the peroxide blend without any accelerator solution.

This data demonstrates the completely unexpected ambient temperature (22.7° C.) stability and 30° C. elevated temperature stability of a pure peroxide blend containing an accelerator system used in the practice of embodiments of the disclosure.

### Comparative Example 4: Decomposition of a Room-Temperature Organic Peroxide as Compared to the Same Room Temperature Organic Peroxide Blended with Only ZnCl₂

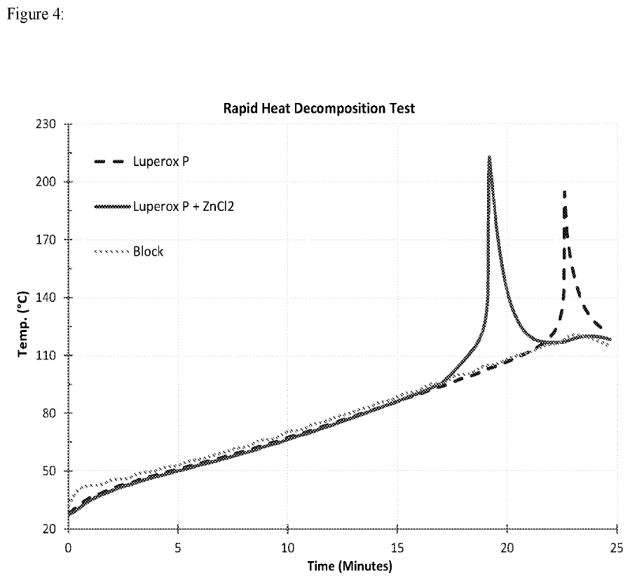

A rapid heat decomposition test was done by placing approximately 1 gram of neat tert-butyl perbenzoate (LUPEROX® P) in one test tube. Approximately 1 gram of the same organic peroxide was placed in a second test tube along with 0.02 g zinc chloride (ZnCl₂). The two test tubes were placed in a block which was heated at approximately 4° C./minute. One can then compare at what temperature the tert-butyl perbenzoate (LUPEROX® P) decomposes. The results are shown below in FIG. 4. FIG. 4 shows that ZnCl₂ destabilizes the organic peroxide, causing it to exotherm sooner than the neat organic peroxide, as would be expected.

### Example 5: Decomposition of a Room-Temperature Organic Peroxide as Compared to the Same Room Temperature Organic Peroxide that has been Combined with Our Novel Accelerator Solution

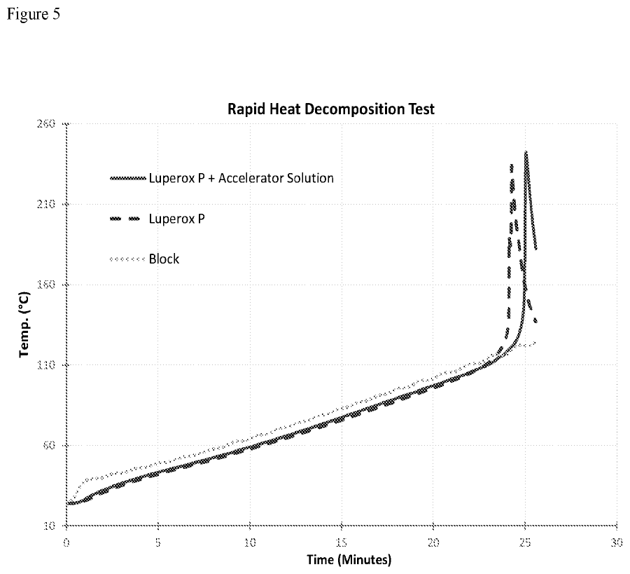

Our accelerator solution: 86.5 wt % DGMBE, 11 wt % PETMP, and 2.5 wt % ZnCl₂ The room-temperature organic peroxide Luperox® P (tert-butyl perbenzoate) chosen for this example was the same the peroxide used in Example 4. For this test, approximately one gram of neat Luperox® P was placed in one test tube. Added to a second test tube was approximately one grain of neat Luperox® P plus 0.20 grams of accelerator solution. That amount of accelerator solution resulted in adding 0.005 g ZnCl₂ into the one gram of Luperox® P peroxide. (Note: PETMP was also present in our novel accelerator solution.) Both solutions were heated at a rate of 4 C per minute so as to rapidly decompose the organic peroxides. (FIG. 5)

The solid curve on FIG. 5 shows that the neat Luperox® P blended with our novel accelerator solution provided surprisingly better thermal stability than the neat Luperox® P peroxide without our novel accelerator solution (dashed curve). Thus very unexpectedly, we show it is possible to create a stable room-temperature peroxide solution containing an accelerator, using the teachings of embodiments of the disclosure.

### Example 6: Evaluation of LiCl (Instead of ZnCl₂) in the Practice of an Embodiment of the Disclosure to Promote a Room Temperature Organic Peroxide for Curing an Unsaturated Polyester Resin at 80° C.

TABLE 4

| Formulation # | #1 | #2 |
|---|---|---|
| Unsaturated Polyester Resin | 97.0 wt % | 97.5 wt % |
| Luperox ® P | 2.50 wt % | 2.50 wt % |
| LiCl Accelerator Solution | 0.50 wt % | 0 wt % |
| Total= | 100 | 100 |

The Lithium Chloride Accelerator Solution contained 88 wt % diethylene glycol mono butyl ether (DGMBE), 10 wt % PETMP and 2 wt % Lithium Chloride.

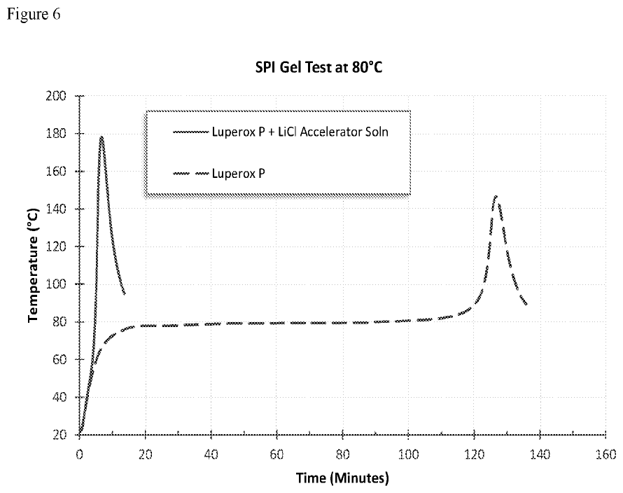

The standard gel test was performed at 80° C. for the curing of UPR, comparing formulation #1 using 2.50 wt % Luperox® P combined with 0.50 wt % of our novel accelerator solution (that used LiCl) versus formulation #2 that used 2.50 wt % Luperox® P but without any LiCl containing accelerator solution. The results plotted in FIG. 6 clearly show that our novel LiCl containing accelerator solution easily promoted Luperox® P which resulted in a very fast cure of the unsaturated polyester resin.

### Example 7 Promotion of a Single Room Temperature Organic Peroxide

In this example, a gel test was run at 60° C. comparing the cure performance of an unsaturated polyester resin to which has been added either Luperox® P or Luperox® P with the addition of our novel ZnCl₂ based accelerator solution. The formulations used in this test are shown in Table 5.

TABLE 5

| Raw Material | Formulation 1 | Formulation 2 |
|---|---|---|
| Unsaturated Polyester Resin | 97.35% | 97.75% |
| Luperox ® P | 2.25% | 2.25% |
| ZnCl₂ Accelerator Solution | 0.4% | 0.0% |

The accelerator solution consisted of 86.5% DGMBE, 11% PETMP, and 2.5% ZnCl₂

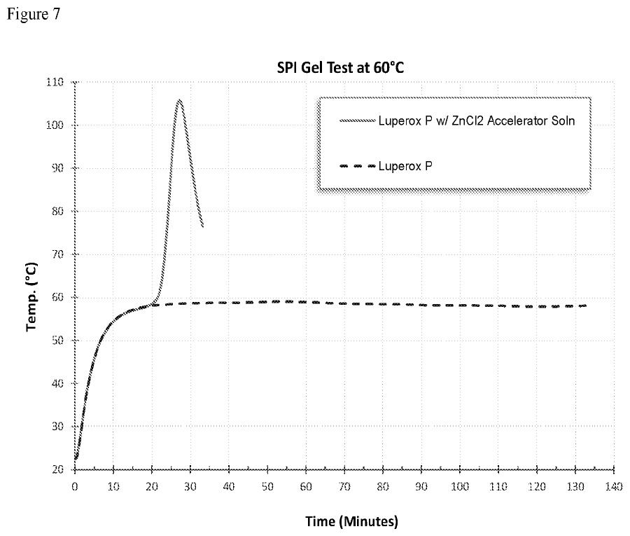

As can be seen in FIG. 7, the formulation containing our novel accelerator solution exotherms and cures in under 30 minutes. In comparison, the formulation that did not have any of the accelerator solution added to it ran for over two hours without showing any evidence of an exothermic reaction.

1. A curable resin composition comprising:
a) at least one curable resin which is capable of being cured by liquid organic peroxide;
b) at least one room-temperature-stable organic peroxide which is in liquid form at 25° C. and has a one-hour half-life temperature of 100° C. or more;
c) optionally at least one non-room-temperature-stable organic peroxide which is in liquid form at 10° C. or less, and has a one-hour half-life temperature of less than 100° C.;
d) at least one salt of at least one metal comprising at least one of Li, Al, Mg, Co, Fe, Cu, Zn, Ni, Mn, Cr, Sn, Au, Pd, or Pt;
e) at least one thiol-functionalized organic compound; and
f) optionally at least one solvent comprising at least one of alcohols, glycols, or glycol ethers.

2. The curable resin composition of claim 1, comprising c) the non-room-temperature-stable organic peroxide.

3. The curable resin composition of claim 1, wherein the at least one thiol-functionalized organic compound includes at least one thiol-functionalized organic compound comprising two or more thiol functional groups.

4. The curable resin composition of claim 1, wherein the at least one thiol-functionalized organic compound comprises at least one α-mercaptoacetate or β-mercaptopropionate ester of an alcohol.

5. The curable resin composition of claim 1, wherein the at least one thiol-functionalized organic compound comprises at least one thiol-functionalized organic compound comprising at least one of dipentene-dimercaptan; ethylcyclohexyldimercaptan; ethylene-1,2-bis-3-mercaptoacetate; ethylene-1,2-bis-3-mercaptopropionate; 1,2,3-propanetrithiol; 1,2,6-hexanetrithiol; pentaerythritolthiol; pentaerythritol tetrakis (2-mercaptoacetate); pentaerythritol tetrakis (3-mercaptopropionate); trimethylol propane tris(3-mercaptopropionate); 1,1,1-propanetriyl tris(mercaptoacetate) and thiolic derivatives of the formula: R—(R′—CH(OH)—CH₂—SH)n wherein R is a linear alkyl group having 3-30 carbon atoms, R′ is a linear alkylene group having 3-30 carbon atoms and n is an integer of 2-6.

6. The curable resin composition of claim 1, wherein the at least one non-room-temperature-stable organic peroxide comprises at least one of diacyl peroxides, peroxydicarbonates; peroxyesters; di(n-propyl) peroxydicarbonate; di(sec-butyl) peroxydicarbonate; di(2-ethylhexyl peroxydicarbonate; 3-hydroxy-1,1-dimethylbutyl peroxyneodecanoate; α-cumyl peroxyneodecanoate; tert-amyl peroxyneodecanoate; α-cumyl peroxyneodecanoate; tert-butyl peroxyneodecanoate; tert-amyl peroxypivalate; tert-butyl peroxypivalate; 2,5-di(2-ethylhexanoylperoxy)-2,5-dimethylhexane; tert-amyl peroxy-2-ethylhexanoate; 1,1,3,3-tetramethylbutylperoxy-2-ethylhexanoate; tert-hexyl peroxy-2-ethylhexanoate; tert-butyl peroxy-2-ethylhexanoate; a solution of dilauryl peroxide; or a solution of dibenzoyl peroxide.

7. (canceled)

8. The curable resin composition of claim 1, wherein the at least one room-temperature-stable organic peroxide comprises at least one of hemiperoxyketals; peroxyesters, monoperoxycarbonates; peroxyketals; 1-tert-amyl peroxy-1-methoxy cyclohexane; tert-butyl peroxyacetate; tert-amyl peroxyacetate; tert-butyl peroxybenzoate; 1,1-di(tert-butylperoxy)-3,3,5-trimethylcyclohexane; 1,1-di(tert-amyl peroxy)-cyclohexane; 1,1-di(1-butylperoxy)-cyclohexane; 2,2-di(tert-butylperoxy)butane; OO-tert-butyl-O-(2-ethylhexyl)-monoperoxycarbonate; OO-tert-amyl-O-(2-ethylhexyl)-monoperoxycarbonate; OO-tert-amyl peroxy-O-isopropyl-monoperoxycarbonate; OO-tert-butylperoxy-O-isopropyl-monoperoxycarbonate; polyether tetrakis(tert-butylperoxycarbonate); or tert-amyl peroxybenzoate.

9. The curable resin composition of claim 1, wherein the at least one salt of at least one metal comprises at least one transition metal halide, nitrate, sulfate, carboxylate, lactate, acetate, hexanoate, or naphthenate.

10. The curable resin composition of claim 9, wherein the at least one salt of at least one metal comprises at least one copper halide or zinc halide or lithium halide.

11. The curable resin composition of claim 1, wherein the at least one curable resin comprises at least one of alkyd resins, unsaturated polyester resins, vinyl ester resins, (meth)acrylate resins, or mixtures or blends thereof.

12. A cured resin composition obtained by curing the curable resin composition of claim 1.

13. A composite comprising the cured resin composition of claim 12 and at least one reinforcing filler.

14.-15. (canceled)

16. A method of making a pultruded, fiber-reinforced, resinous article comprising:
coating continuous fiber strands with the curable resin composition of claim 1 to obtain resin-coated continuous fiber strands;
pulling the resin-coated continuous fiber strands through a shaping zone to provide an elongated structure; and
heating the curable resin composition to a temperature effective to initiate curing of the curable resin composition.

17. A method of making a cured-in-place pipe, comprising:
impregnating a liner with the curable resin composition of claim 1 to obtain an impregnated liner;
placing the impregnated liner material within an existing pipe; and
heating the impregnated liner within the existing pipe to a temperature effective to initiate curing of the curable resin composition.

18. A method of making a resin transfer molded article, comprising:
impregnating fiber reinforcement in matched mold tooling with the curable resin composition of claim 1 to obtain a composite part.

19. A method of preparing a cured composition, the method comprising:
combining:
a) at least one curable resin which is capable of being cured by an organic peroxide;
b) at least one room-temperature-stable organic peroxide which is in liquid form at 25° C. and has a 1 hour half-life temperature of 100° C. or more;
c) optionally at least one non-room-temperature-stable organic peroxide which is in liquid form at 10° C. or less and has a one-hour half-life temperature of less than 100° C.,
d) at least one salt of at least one metal comprising at least one of Li, Al, Mg, Co, Fe, Cu, Zn, Ni, Mn, Cr, Sn, Au, Pd, or Pt;
e) at least one thiol-functionalized organic compound; and
f) optionally at least one solvent comprising at least one of alcohols, glycols, or glycol ethers;
to provide a curable resin composition; and
heating the curable resin composition to a temperature effective to initiate curing of the curable resin composition.

20. A curing system comprising:
i) a first component comprising:
at least one room-temperature-stable organic peroxide which is in liquid form at 25° C. and has a one-hour half-life temperature of 100° C. or more; and
at least one non-room-temperature-stable organic peroxide which is in liquid form at 10° C. or less and has a one-hour half-life temperature of less than 100° C.;
wherein said first component optionally is substantially devoid of styrene, and
ii) a second component comprising:
at least one salt of at least one metal comprising at least one of Li, Al, Mg, Co, Fe, Cu, Zn, Ni, Mn, Cr, Sn, Au, Pd, or Pt;
at least one thiol-functionalized organic compound; and
optionally at least one solvent comprising at least one of alcohols, glycols, or glycol ethers.

21. The curing system of claim 20 wherein the first component is substantially devoid of styrene and the second component comprises the at least one solvent comprising at least one of alcohols, glycols, or glycol ethers.

22.-37. (canceled)

38. The curable resin composition of claim 1, wherein:
the first peroxide comprises tert-amyl peroxy-2-ethylhexanoate or 1,1,3,3-tetramethylbutylperoxy-2-ethylhexanoate;
the second peroxide comprises tert-butyl-peroxybenzoate;
the metal halide comprises ZnCl₂;
the solvent comprises diethylene glycol mono butyl ether, and
the thiol compound comprises pentaerythritol tetrakis(3-mercaptopropionate).
